(19) United States
(12) Patent Application Publication
(10) Pub. No.: US 2025/0384650 A1
(43) Pub. Date: Dec. 18, 2025

(54) Open-Vocabulary Object Detection Based on Frozen Vision and Language Models

(71) Applicant: Google LLC, Mountain View, CA (US)

(72) Inventors: Wei-Cheng Kuo, Santa Clara, CA (US); Yin Cui, Mountain View, CA (US); Xiuye Gu, Mountain View, CA (US); Anthony Jacob Piergiovanni, Denver, CO (US); Anelia Angelova, Palo Alto, CA (US)

(21) Appl. No.: 18/878,592

(22) PCT Filed: Jun. 28, 2023
(86) PCT No.: PCT/US2023/026432

§ 371 Date: Dec. 23, 2024

Related U.S. Application Data
(60) Provisional application No. 63/367,178, filed on Jun. 28, 2022.

(51) Int. Cl. G06V 10/25; G06V 10/44; G06V 10/82; G06V 20/70

(52) U.S. Cl. CPC G06V 10/25; G06V 10/44; G06V 10/82; G06V 20/70; G06V 2201/07

(57) ABSTRACT

An example method of training a detector head for object detection of a training object category based on a frozen vision and language model (VLM) is provided. The method includes receiving the frozen VLM pre-trained on a plurality of image-text pairs. The method includes determining, for an image embedding generated by a pre-trained image encoder of the frozen VLM and by the detector head, a detection region embedding indicative of one or more regions of interest in an image. The method includes generating, by a pre-trained text encoder of the frozen VLM, a text embedding of the training object category. The method includes predicting, by the detector head and based on the detection region embedding and the text embedding of the training object category, an object from a target object vocabulary associated with the training object category. The method includes providing the pre-trained frozen VLM and the trained detector head.

### CROSS-REFERENCE TO RELATED APPLICATIONS/INCORPORATION BY REFERENCE

This application claims priority to U.S. Provisional Patent Application No. 63/367,178, filed on Jun. 28, 2022, which is hereby incorporated by reference in its entirety.

### BACKGROUND

Object detection is a vision task generally based on an algorithm to localize and recognize objects in an image. Object detection entails recognition and localization of objects across various scales.

### SUMMARY

Some object detection models rely on a trained vocabulary, and are therefore not suitable for open-vocabulary object detection. Generally, open-vocabulary object detection can leverage other sources of supervision such as image captions, or vision and language pre-training. Due to a need for region-level generalization, such methods typically involve knowledge distillation, region distillation on external data, or pre-training with image-level captions, in addition to the standard detection training. Some methods rely on pre-trained vision and language models (VLMs) for generalization. VLMs are capable of generating rich knowledge and a strong representation for both visual and linguistic domains. However, in many VLMs, the entire detector head may need to be trained from scratch. Some VLMs rely on a separate pre-training and fine-tuning process. However, these models may suffer from a lack of an ability to scale, and the re-training, pre-training, and/or fine-tuning for detection, may be computationally resource intensive.

Accordingly, there is a need for a simple and scalable open-vocabulary detection approach that can extract locality sensitive information with a lightweight detector head. In particular, as described herein, a detector head can be trained upon a frozen VLM backbone, and detection scores from the detector head can be combined with the corresponding VLM predictions at test time.

In one aspect, a computer-implemented method of training a detector head for object detection of a training object category based on a frozen vision and language model (VLM) is provided. The method includes receiving, by a computing device, the frozen VLM pre-trained on a plurality of image-text pairs. The method also includes determining, for an image embedding generated by a pre-trained image encoder of the frozen VLM and by the detector head, a detection region embedding indicative of one or more regions of interest in an image. The method additionally includes generating, by a pre-trained text encoder of the frozen VLM, a text embedding of the training object category. The method further includes predicting, by the detector head and based on the detection region embedding and the text embedding of the training object category, an object from a target object vocabulary associated with the training object category. The method also includes providing, by the computing device, the pre-trained frozen VLM and the trained detector head.

In a second aspect, a computing device is provided. The computing device includes one or more processors and data storage. The data storage has stored thereon computer-executable instructions that, when executed by one or more processors, cause the computing device to carry out functions of training a detector head for object detection of a training object category based on a frozen vision and language model (VLM). The functions include: receiving, by a computing device, the frozen VLM pre-trained on a plurality of image-text pairs; determining, for an image embedding generated by a pre-trained image encoder of the frozen VLM and by the detector head, a detection region embedding indicative of one or more regions of interest in an image; generating, by a pre-trained text encoder of the frozen VLM, a text embedding of the training object category; predicting, by the detector head and based on the detection region embedding and the text embedding of the training object category, an object from a target object vocabulary associated with the training object category; and providing, by the computing device, the pre-trained frozen VLM and the trained detector head.

In a third aspect, a computer program is provided. The computer program includes instructions that, when executed by a computer, cause the computer to carry out functions of training a detector head for object detection of a training object category based on a frozen vision and language model (VLM). The functions include: receiving, by a computing device, the frozen VLM pre-trained on a plurality of image-text pairs; determining, for an image embedding generated by a pre-trained image encoder of the frozen VLM and by the detector head, a detection region embedding indicative of one or more regions of interest in an image; generating, by a pre-trained text encoder of the frozen VLM, a text embedding of the training object category; predicting, by the detector head and based on the detection region embedding and the text embedding of the training object category, an object from a target object vocabulary associated with the training object category; and providing, by the computing device, the pre-trained frozen VLM and the trained detector head.

In a fourth aspect, an article of manufacture is provided. The article of manufacture includes one or more computer readable media having computer-readable instructions stored thereon that, when executed by one or more processors of a computing device, cause the computing device to carry out functions of training a detector head for object detection of a training object category based on a frozen vision and language model (VLM). The functions include: receiving, by a computing device, the frozen VLM pre-trained on a plurality of image-text pairs; determining, for an image embedding generated by a pre-trained image encoder of the frozen VLM and by the detector head, a detection region embedding indicative of one or more regions of interest in an image; generating, by a pre-trained text encoder of the frozen VLM, a text embedding of the training object category; predicting, by the detector head and based on the detection region embedding and the text embedding of the training object category, an object from a target object vocabulary associated with the training object category; and providing, by the computing device, the pre-trained frozen VLM and the trained detector head.

In a fifth aspect, a system to carry out functions of training a detector head for object detection of a training object category based on a frozen vision and language model (VLM) is provided. The system includes means for receiving, by a computing device, the frozen VLM pre-trained on a plurality of image-text pairs; means for determining, for an image embedding generated by a pre-trained image encoder of the frozen VLM and by the detector head, a detection region embedding indicative of one or more regions of interest in an image; means for generating, by a pre-trained text encoder of the frozen VLM, a text embedding of the training object category; means for predicting, by the detector head and based on the detection region embedding and the text embedding of the training object category, an object from a target object vocabulary associated with the training object category; and means for providing, by the computing device, the pre-trained frozen VLM and the trained detector head.

In a sixth aspect, a computer-implemented method of applying a trained detector head for object detection of a training object category based on a frozen vision and language model (VLM) is provided. The method includes receiving, by a computing device, an input image. The method also includes applying a trained neural network for object detection, wherein the neural network comprises the frozen VLM pre-trained on a plurality of image-text pairs, and the trained detector head associated with the pre-trained frozen VLM and pre-trained on the training object category. The method additionally includes determining, for an image embedding generated by a pre-trained image encoder of the frozen VLM and by the detector head, a detection region embedding indicative of one or more regions of interest in the input image. The method also includes predicting, by the detector head and based on the detection region embedding and a text embedding of the training object category, an object from a target object vocabulary associated with the training object category. The method additionally includes providing, by the computing device, the input image with the object from the target object vocabulary.

In a seventh aspect, a computing device for applying a trained detector head for object detection of a training object category based on a frozen vision and language model (VLM) is provided. The computing device includes one or more processors and data storage. The data storage has stored thereon computer-executable instructions that, when executed by one or more processors, cause the computing device to carry out functions. The functions include: receiving, by a computing device, an input image; applying a trained neural network for object detection, wherein the neural network comprises the frozen VLM pre-trained on a plurality of image-text pairs, and the trained detector head associated with the pre-trained frozen VLM and pre-trained on the training object category; determining, for an image embedding generated by a pre-trained image encoder of the frozen VLM and by the detector head, a detection region embedding indicative of one or more regions of interest in the input image; predicting, by the detector head and based on the detection region embedding and a text embedding of the training object category, an object from a target object vocabulary associated with the training object category; and providing, by the computing device, the input image with the object from the target object vocabulary.

In an eighth aspect, a computer program for applying a trained detector head for object detection of a training object category based on a frozen vision and language model (VLM) is provided. The computer program includes instructions that, when executed by a computer, cause the computer to carry out functions. The functions include: receiving, by a computing device, an input image; applying a trained neural network for object detection, wherein the neural network comprises the frozen VLM pre-trained on a plurality of image-text pairs, and the trained detector head associated with the pre-trained frozen VLM and pre-trained on the training object category; determining, for an image embedding generated by a pre-trained image encoder of the frozen VLM and by the detector head, a detection region embedding indicative of one or more regions of interest in the input image; predicting, by the detector head and based on the detection region embedding and a text embedding of the training object category, an object from a target object vocabulary associated with the training object category; and providing, by the computing device, the input image with the object from the target object vocabulary.

In a ninth aspect, an article of manufacture for applying a trained detector head for object detection of a training object category based on a frozen vision and language model (VLM) is provided. The article of manufacture includes one or more computer readable media having computer-readable instructions stored thereon that, when executed by one or more processors of a computing device, cause the computing device to carry out functions. The functions include: receiving, by a computing device, an input image; applying a trained neural network for object detection, wherein the neural network comprises the frozen VLM pre-trained on a plurality of image-text pairs, and the trained detector head associated with the pre-trained frozen VLM and pre-trained on the training object category; determining, for an image embedding generated by a pre-trained image encoder of the frozen VLM and by the detector head, a detection region embedding indicative of one or more regions of interest in the input image; predicting, by the detector head and based on the detection region embedding and a text embedding of the training object category, an object from a target object vocabulary associated with the training object category; and providing, by the computing device, the input image with the object from the target object vocabulary.

In a tenth aspect, a system for applying a trained detector head for object detection of a training object category based on a frozen vision and language model (VLM) is provided. The system includes means for receiving, by a computing device, an input image; applying a trained neural network for object detection, wherein the neural network comprises the frozen VLM pre-trained on a plurality of image-text pairs, and the trained detector head associated with the pre-trained frozen VLM and pre-trained on the training object category; means for determining, for an image embedding generated by a pre-trained image encoder of the frozen VLM and by the detector head, a detection region embedding indicative of one or more regions of interest in the input image; means for predicting, by the detector head and based on the detection region embedding and a text embedding of the training object category, an object from a target object vocabulary associated with the training object category; and means for providing, by the computing device, the input image with the object from the target object vocabulary.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE FIGURES

FIG. 1 is a diagram illustrating an example training phase for a neural network, in accordance with example embodiments.

FIG. 2 is a diagram illustrating an example inference phase for a neural network, in accordance with example embodiments.

FIG. 3 is a table illustrating comparisons between various object detection models, in accordance with example embodiments.

FIG. 4 is another table illustrating comparisons between various object detection models, in accordance with example embodiments.

FIG. 5 is a table illustrating example results on various test datasets, in accordance with example embodiments.

FIG. 6 is a table illustrating example results for performance and training cost trade-off, in accordance with example embodiments.

FIG. 7 illustrates examples of object detection tasks on various images, in accordance with example embodiments.

FIG. 8A is a table illustrating example results for VLM-score weights for novel classes, in accordance with example embodiments.

FIG. 8B is a table illustrating example results for the use of arithmetic vs. geometric means to fuse the VLM and detection scores, in accordance with example embodiments.

FIG. 9A is a table illustrating score fusion parameters, in accordance with example embodiments.

FIG. 9B is a table illustrating score fusion parameters, in accordance with example embodiments.

FIG. 9C is a table illustrating score fusion parameters, in accordance with example embodiments.

FIG. 10A displays an example table illustrating the feature pyramid capacity, in accordance with example embodiments.

FIG. 10B displays an example table illustrating effects of background weights on open-vocabulary detection, in accordance with example embodiments.

FIG. 10C displays an example table illustrating benchmarks on computation-friendly training, in accordance with example embodiments.

FIG. 11 is a table summarizing example hyper-parameters for LVIS and COCO benchmarking, in accordance with example embodiments.

FIG. 12 illustrates examples of F-VLM feature clusters, in accordance with example embodiments.

FIG. 13 illustrates examples of LVIS novel category detection, in accordance with example embodiments.

FIG. 14 illustrates examples of Objects365 transfer object detection, in accordance with example embodiments.

FIG. 15 illustrates examples of object detection in an indoor scene, in accordance with example embodiments.

FIG. 16 illustrates examples of object detection in a grocery store scene, in accordance with example embodiments.

FIG. 17 is a diagram illustrating training and inference phases of a machine learning model, in accordance with example embodiments.

FIG. 18 depicts a distributed computing architecture, in accordance with example embodiments.

FIG. 19 is a block diagram of a computing device, in accordance with example embodiments.

FIG. 20 depicts a network of computing clusters arranged as a cloud-based server system, in accordance with example embodiments.

FIG. 21 is a flowchart of a method, in accordance with example embodiments.

FIG. 22 is a flowchart of another method, in accordance with example embodiments.

### DETAILED DESCRIPTION

This application relates, in one aspect, to an open-vocabulary object detection method built upon Frozen Vision and Language Models (F-VLM). In another aspect, this application relates to training an open-vocabulary object detection model. In particular, this application relates to training only the detector head and combining the detector and VLM outputs for each region at inference time.

Vision and language models (VLMs) have gained strong open-vocabulary visual recognition capability by learning from Internet-scale image-text pairs. They are typically applied to zero-shot classification (e.g., on ImageNet) using frozen weights without fine-tuning, which stands in stark contrast to the existing paradigms of retraining or fine-tuning when applying VLMs for open-vocabulary detection.

Zero-shot and open-vocabulary recognition is a long-standing problem in computer vision. Some existing methods have used the visual attributes to represent categories as binary codebooks and learn to predict the attributes for novel categories. Other methods involve learning a joint image-text embedding space using deep learning. Many works have shown the promise of representation learning from natural language associated with images, such as image tags or text descriptions. Recent models have explored large VLMs that are scaled up by training on billions of image-text pairs and that acquire strong image-text representation by contrastive learning (e.g., using Contrastive Language-Image Pre-Training (CLIP)). These models achieve a high degree of zero-shot performance on many classification benchmarks and show benefits in scaling model capacity.

While such methods are based on image-level recognition, object-level understanding may provide more effective models. Frozen classification models have been demonstrated to be beneficial for closed-vocabulary detection with adequate detector head capacity. In addition, a frozen VLM may serve as a teacher model and can combine self-training for zero-shot semantic segmentation. However, as described herein, a frozen VLM may be used directly as part of an open-vocabulary object detector.

Zero-Shot and/or Open-vocabulary object detection may be costly and labor-intensive to scale up data collection and annotation for large vocabulary detection. Zero-shot detection aims to alleviate the challenge by learning to detect novel categories not present in the training data. Existing techniques address this by aligning the image region features to category word embeddings, or by synthesizing visual features with a generative model. Open-vocabulary detection (OVD) benchmarks have been introduced with a view to bridge the performance gap between zero-shot detection (ZSD) and supervised learning. Such models may be first pre-trained on image-caption data to recognize novel objects, and then fine-tuned for zero-shot detection.

Following the OVD benchmark, Vision and Language knowledge Distillation (ViLD) models distill the rich representation of pre-trained VLM into the detector, and detection prompt (DetPro) also improves upon ViLD by applying the idea of prompt optimization. RegionCLIP develops a region-text pre-training strategy that leverages pre-trained VLMs and image-caption data, while Detector with Image Classes (Detic) jointly trains a detector with weak supervision. Also, for example, Vision & Language-Pseudo Label Model VL-PLM explores pseudo-labeling on unlabeled data with object proposals and VLMs for OVD. Another model, grounded language-image pre-training (GLIP) formulates object detection as a phrase grounding task and pre-trains on a wide variety of detection, grounding, and caption datasets for zero/few-shot object detection. Similarly, Vision Transformer for Open-World Localization (OWL-ViT) fine-tunes pre-trained vision transformers on a suite of detection/grounding datasets. Such methods are generally based on training the entire detector from scratch, fine-tuning after detection-tailored pre-training, and/or training on a suite of detection/grounding datasets. In contrast, the model described herein trains only the standard detector head upon a frozen VLM without using any of the above additional techniques.

In order to align the image content with the text description during training, VLMs may learn locality sensitive and discriminative features that are transferable to object detection. Surprisingly, features of a frozen VLM contain rich information that are both locality sensitive for describing object shapes and discriminative for region classification. This motivates us to explore using frozen VLM features for open-vocabulary detection, which entails accurate localization and classification of objects in the wild.

### Overview

A full open-vocabulary object detection model built upon frozen vision language models (F-VLM) is described. The term “frozen” as used herein, generally refers to a state of a neural network where the weights associated with layers of the neural network are not subject to change, and where, for a given input, the output from a layer of the neural network is the same during all epochs. In other words, a frozen neural network may be considered to have been optimized for its respective performance, and is maintained in such an optimized state. The F-VLM model is configured to scale with frozen model capacity.

The overall framework is conceptually simple yet effective. Directly using a frozen pre-trained vision and language model is easier to deal with than performing knowledge distillation and/or weakly supervised learning. And the training cost is significantly lower than other models because the entire language model is frozen. Strong quantitative results are illustrated on a Large Vocabulary Instance Segmentation (LVIS) dataset and a Common Objects in Context (COCO) dataset. Qualitative cross-dataset generalization results on massive-scale Egocentric dataset (Ego4D) are also illustrated.

At training time, the model has access to the detection labels of C_{B} base categories, but needs to detect objects from a set of Cy novel categories at test time. To make the settings more practical, a pre-trained vision and language model (VLM) that has learned from plenty of image-text pairs on the internet may be utilized.

As described herein, the model retains, from the VLM backbone, locality-sensitive features necessary for downstream detection, while performing as a strong object classifier. The described techniques reduce training complexity by simplifying current multi-stage training pipelines. For example, a need for knowledge distillation or detection-tailored pre-training is eliminated.

Generally, the underlying VLM may be frozen (and is generally referred to herein as “F-VLM”), and the detector head may be the trainable component. This results in fewer trainable parameters than competing generalizable models.

The described F-VLM can result in approximately 200× reduction in computational savings. The technique appears to surpass the state-of-the-art detection benchmark on the Large Vocabulary Instance Segmentation (LVIS) dataset by 6.5 April, and by 5.6 on the overall mask AP. Also, for example, F-VLM can be significantly faster and less expensive to train. For example, F-VLM can train with very few epochs (e.g. 14.7), and achieve a state of the art APr of 31.0. The described techniques enable generalization to novel categories and new datasets without a need for complete retraining of the model, training on a suite of detection/grounding datasets, and/or fine-tuning after detection-tailored pre-training. In some implementations, the detector head may be a Faster R-CNN including a feature pyramid network.

The model can utilize class-agnostic box regression and mask prediction heads. Accordingly, for each region proposal, the model can predict one box and one mask for all categories, rather than one per category, thereby localizing novel objects in the open-vocabulary settings. The technique has comparable performance with Region-based Language-Image Pre-training (RegionCLIP) on the Common Objects in Context (COCO) open vocabulary object detection benchmark. The technique also has comparable performance with the state-state-of-the-art method for generalizing from the LVIS dataset to the COCO and Objects365 datasets.

In some embodiments, detector scores may be combined with corresponding VLM predictions to obtain open-vocabulary object detection scores. In some embodiments, an image encoder may be used for pre-training, and a text encoder may be used for caching the text embeddings of the detection dataset vocabulary offline. Also, for example, the last fully connected layer of the described model can include text embeddings of initial object categories, and may be expanded to include novel object categories for open-vocabulary detection.

Optimal values of factors that weigh a relative influence of the initial and the novel object categories may be derived. Also, F-VLM trained on one dataset can be directly applied to another by swapping out the vocabulary without any fine-tuning.

Pre-Training from Vision and Language Models

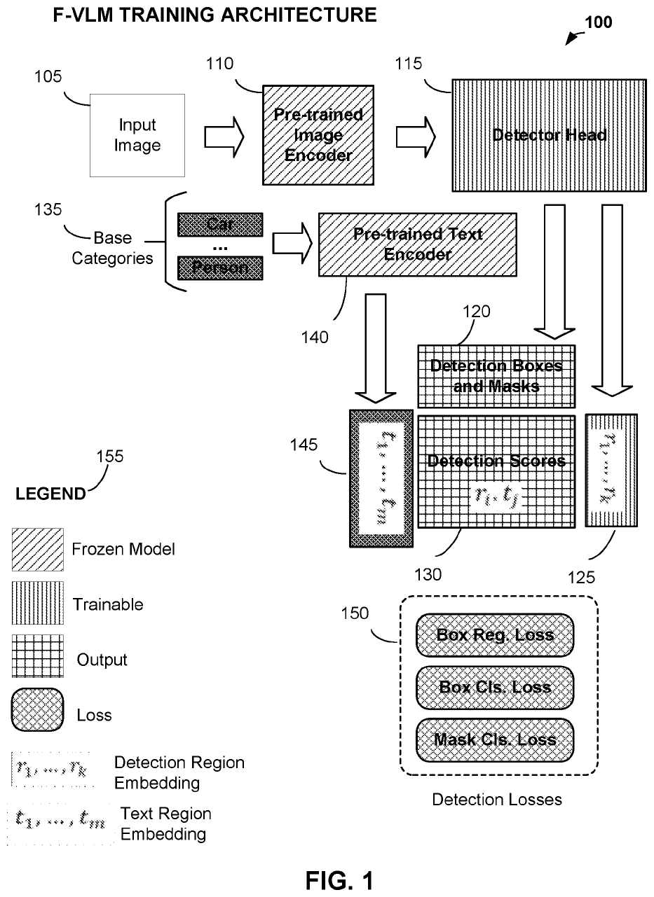

FIG. 1 is a diagram illustrating an example training architecture 100 for a neural network, in accordance with example embodiments. Input image 105 may be input into a pre-trained image encoder 110. The pre-trained image encoder 110 may be used as a frozen model.

The encoded image may be provided to a trainable detector head 115. Detector head 115 may generate one or more detection boxes and masks 120. Detector head 115 may also provide image embeddings 125, denoted as r₁, . . . , rₖ, to a detection scoring component 130 to generate detection scores.

A plurality of base categories 135 may be utilized for training purposes. For example, base categories such as “cars,” “person,” and so forth may be provided to a pre-trained text encoder 140. Similar to image encoder 110, text encoder 140 may be used as a frozen model to generate text embeddings 145, denoted as t₁, . . . , tₘ. Text encoder 140 may provide text embeddings 145 to detection scoring component 130 to generate detection scores. Detection scoring component 130 generates and outputs detection scores, denoted rᵢ.tⱼ, where i=1, . . . , k, and j=1, . . . , m, for the one or more detection boxes and masks 120, based on image embeddings 125 and text embeddings 145. The detection scores One or more loss functions 150 may be evaluated. For example, a box region loss, a box classification loss, and/or or a mask classification loss may be determined for training. Legend 155 denotes the various types of models that are used.

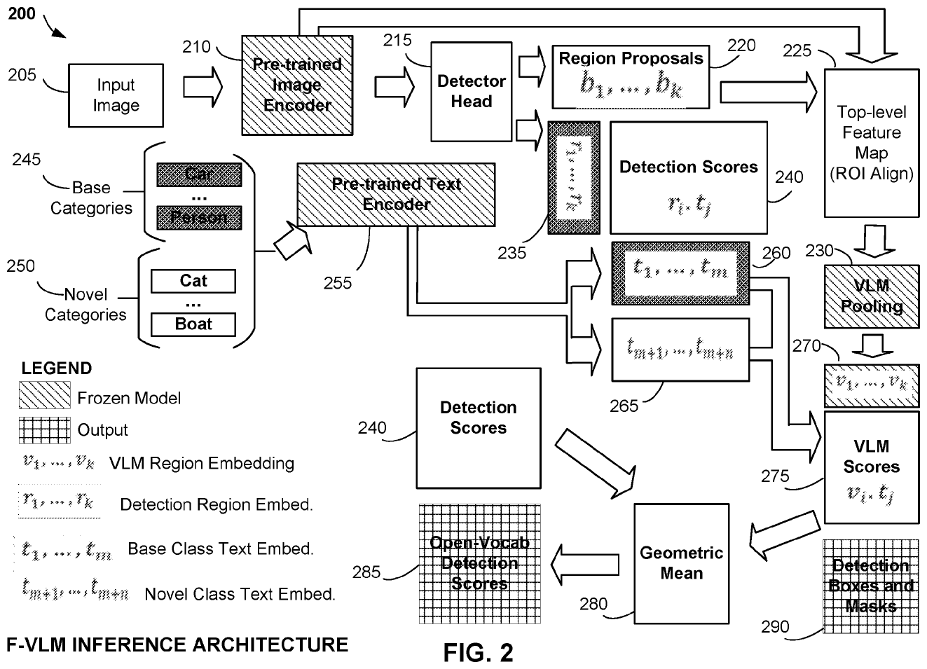

FIG. 2 is a diagram illustrating an example inference architecture 200 for a neural network, in accordance with example embodiments. Input image 205 may be input into a pre-trained image encoder 210. The pre-trained image encoder 210 may provide the encoded image to a trained detector head 215. Detector head 215 may generate region proposals 220, denoted as b₁, . . . , bₖ. Detector head 215 may also provide image embeddings 235, denoted as r₁, . . . , rₖ, to a detection scoring component 240 to generate detection scores. Trained detector head 215 may generate one or more detection boxes and masks 290.

Region proposals 220 may be provided to a top-level feature map generator 225. In some embodiments, top-level feature map generator 225 may receive the encoded image from pre-trained image encoder 210. Also, for example, top-level feature map generator 225 may perform ROI alignment based on the encoded image and region proposals 220. The output may be provided to a frozen layer of the neural network, VLM pooling layer 230. VLM pooling layer 230 provides features 270, denoted as v₁, . . . , vₖ to VLM scoring component 275 to generate VLM scores.

As described with respect to FIG. 1, the neural network may have been trained on a plurality of base categories 245 (e.g., “cars,” “person,” and so forth). Pre-trained text encoder 255 may generate text embeddings 260, denoted as t₁, . . . , tₘ. However, a plurality of novel categories 250 (e.g., “cat,” “boat,” and so forth), not previously input during training, may be provided to pre-trained text encoder 255. Text encoder 255 may generate additional text embeddings 265, denoted as tₘ₊₁, . . . , tₘ₊ₙ. Text encoder 255 may provide text embeddings 260 and additional text embeddings 265 to detection scoring component 240 to generate detection scores. Based on image embeddings 235, text embeddings 260, and additional text embeddings 265, detection scoring component 240 generates detection scores, denoted rᵢ.tⱼ, where i=1, . . . , k, and j=1, . . . , m, m+1, . . . , m+n.

In some embodiments, VLM scoring component 275 receives text embeddings 260, and additional text embeddings 265, and generates VLM scores, denoted vᵢ.tⱼ, where i=1, . . . , k, and j=1, . . . , m, m+1, . . . , m+n.

In some embodiments, the detection scores from detection scoring component 240 may be combined with VLM scores VLM scoring component 275. For example, a geometric mean 280 of the detection scores and the VLM scores may be determined, and open-vocab detection scores 285 may be output for the detection boxes and masks 290.

These and other aspects of F-VLM are described in additional detail. In what follows, FIGS. 1 and 2 may be referenced interchangeably as they share common components.

At test time, F-VLM uses the detection boxes 290 to crop out the top-level features 225 of frozen VLM backbone and compute the VLM scores 275 for each region. The trained detector head 215 provides the localization, while the classification (e.g., open-vocab detection scores 285) is a combination of detection scores 240 and VLM scores 275. In some embodiments, the open-vocabulary object detector may be built upon frozen VLMs by training only the detector head upon frozen features, which can guarantee to preserve the open-vocabulary classification ability of pre-trained VLMs. At test time, we combine the detection scores 240 with the VLM scores 275 to obtain open-vocabulary object detection scores 285. By directly using frozen pre-trained models (e.g., image encoder 210, text encoder 255, VLM pooling 230), the approach is simple and easily scalable.

With reference to FIG. 1, at training time, F-VLM is a standard detector with the last classification layer of the neural network replaced by the text embeddings 145 from base categories 135. The detector head 115 may be trained, while the remaining model may be frozen.

Vision and Language Models (VLM) are popular because of their rich knowledge and strong representation for both visual and linguistic domains. Using a frozen VLM enables the neural network to retain such knowledge as much as possible, in order to minimize the effort and/or cost to adapt the VLMs for open-vocabulary detection. For illustrative purposes, contrastively pre-trained VLMs are described. Contrastive VLMs typically have the image and text encoders trained jointly with a contrastive objective. Contrastive VLMs lend themselves easily to the detection and/or segmentation tasks and have been adopted by existing open-vocabulary detection and/or segmentation models. A frozen image encoder 110 may be used as the detector backbone, and a frozen text encoder 140 for caching the text embeddings of detection dataset vocabulary offline.

In some embodiments, the VLM image encoder 110 may comprise two parts: 1) a feature extractor [symbol] (.), such as, for example, ResNet-50, and 2) a last feature pooling layer [symbol] (.), such as, for example, an attention pooling layer. The same backbone architecture as the image feature extractor [symbol] (.) may be used, and this can enable direct use of frozen weights, as well as allow rich semantic knowledge to be inherited. Along with the backbone initialization, the same image pre-processing scheme as the VLM pre-training may be used to maintain the open-vocabulary recognition ability. The last VLM pooling layer [symbol] (.) (e.g., VLM pooling 230 of FIG. 2) may be used for open-vocabulary recognition at test time. Building upon the frozen backbone features, a Mask R-CNN head may be used for the detector head, and a feature pyramid network as the detector head. The detector head may be randomly initialized and may be the only trainable component of F-VLM, as illustrated in FIG. 1. Despite the image-level pre-training, the frozen VLM backbone appears to include adequate locality-sensitive features to enable accurate downstream detection.

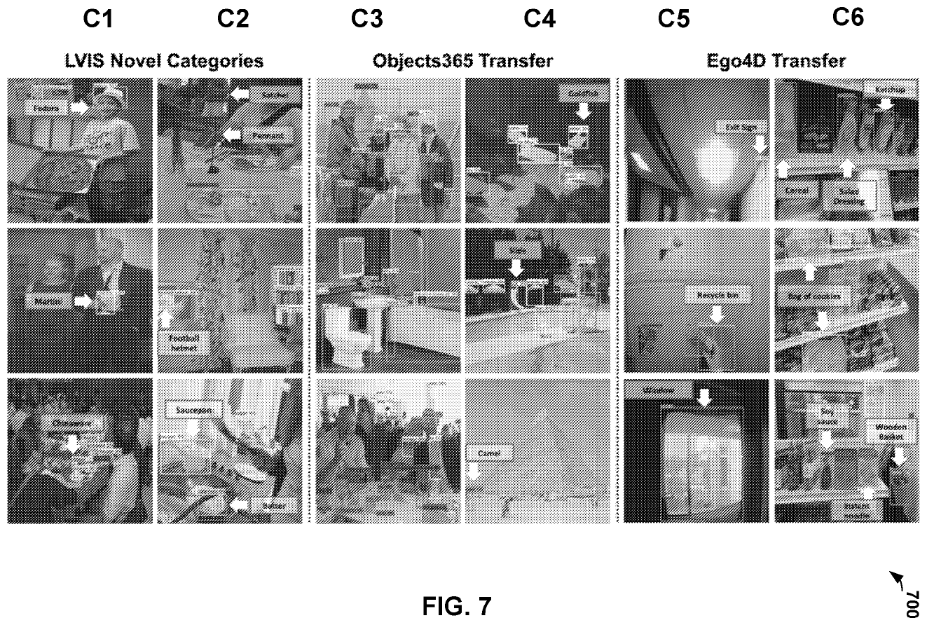

For example, to understand the effectiveness of F-VLM, a k-means clustering may be performed to probe the structures present in the frozen VLM features (e.g. CLIP). In some embodiments, a CLIP R50×4 backbone and LVIS dataset may be used for visualization. Generally, the last layer output features may be used for clustering, because these features can be used for zero-shot region classification at the same time. FIG. 7 demonstrates that the features form clusters around salient objects of the scenes (e.g., skis, motorbikes, people), and naturally separate object parts (e.g., donut toppings, bus wheels) without explicit supervision.

### Text-Embedding Region Classifier

For a more precise description, input image 105 may be denoted as I, and the backbone features from the image encoder may be denoted as [symbol] (I). The function that yields a region embedding r_{b} from [symbol] (I) may be denoted as [symbol] (.), and a given box region proposal may be denoted as b. In some embodiments, the box region proposal may involve FPN, ROI-Align, and Faster R-CNN head. Accordingly,

$${r}_{b} = ( ℱ ( I ) , b ) \qquad ( Eqn . 1 )$$

Standard detectors generally use a K-way classifier because the training and test time categories are the same. However, such a design does not support the open-vocabulary settings where new categories may be added at test time. To accommodate this, the last fully connected layer may be replaced with the text embeddings 145 of base categories 135 (see FIG. 1). At inference time, the text embeddings may then be expanded to include text embeddings 260 of base categories 245, and additional text embeddings 265 of novel categories 250, for open-vocabulary detection (see FIG. 2). An advantage of such a design is that the system can generalize to the novel categories near C_{B} in the embedding space.

To generate text embeddings, it may be desirable to use the matching text encoder 140 (resp. text encoder 265) of the image encoder 110 (resp. image encoder 210), because they may have been pre-trained jointly. Apart from C_{B}, a background category may be represented by a generic phrase “background” for compatibility with other categories. At training time, the region proposals 220 that are not matched to ground truth boxes in C_{B} may be treated as background. For each region, a cosine similarity of r_{b} with the text embeddings of C_{B} and “background” may be determined, and a learnable temperature t may be applied on the logits. The detection scores z(r_{b}) may be determined as:

$$z ( {r}_{b} ) = Softmax ( \frac{1}{τ} [ cos ( {r}_{b} , {t}_{gb} ) , cos ( {r}_{b} , {t}_{1} ) , ... , cos ( {r}_{b} , {t}_{\vert {C}_{B} \vert} ) ] ) \qquad ( Eqn . 2 )$$

where cos(a, b)=a^{T}b/(∥a∥∥b∥), and tᵢ denotes the text embeddings of class i. A standard softmax cross entropy loss may be applied on the logits (see FIG. 1). At test time, the “background” category may be maintained, and the text embeddings may be expanded from C_{B} to C_{B} ∪C_{N} to include base categories 245 and novel categories 250 for open-vocabulary detection.

### Open-Vocabulary Recognition

The ability to perform open-vocabulary recognition at a regional level is an additional benefit of F-VLM. Since the backbone features are frozen, they generally do not overfit to the base categories and can be directly cropped for region-level classification. F-VLM performs this open-vocabulary classification at test time (e.g., top-level feature map 225 of FIG. 2).

To obtain the features for a region b, the VLM pooling layer 230, denoted as [symbol] (.), may be applied on the cropped backbone output features [symbol] (I). Because the VLM pooling layer 230 receives fixed-size inputs, such as, for example, 7×7 for R50, the region features may be cropped and resized with ROI-Align [symbol] (.) (see top-level feature map 225 of FIG. 2). Unlike existing models, the embeddings of the cropped and resized RGB image regions do not need to be cached in a separate offline process. The detector head 215 is trained in one stage. This reduces complexity and can be more space-efficient. In addition, the VLM region features with [symbol] (.) are not cropped during training because the backbone features are frozen. Generally, the VLM region embedding v_{b} may be determined as:

$${𝓋}_{b} = 𝒫 ( ℛ ( ℱ ( I ) , b ) ) \qquad ( Eqn . 3 )$$

where b denotes the box region and v_{b} corresponds to features 270 denoted as v₁, . . . , vₖ in FIG. 2. As described, [symbol] (.) is used at test time and not during training. Similar to Eqn. 2 for detection scores, the VLM scores may be determined by cosine similarity as follows:

$$w ( {𝓋}_{b} ) = Softmax ( \frac{1}{T} [ cos ( {ν}_{b} , {t}_{gb} ) , cos ( {ν}_{b} , {t}_{1} ) , ... , cos ( {𝓋}_{b} , {t}_{\vert {C}_{B} ⋃ {C}_{N} \vert} ) ] ) \qquad ( Eqn . 4 )$$

where T is a fixed temperature parameter and the text embeddings include both the C_{B} and C_{N} at inference time (see base categories 245 and novel categories 250 of FIG. 2). In some embodiments, a fixed temperature parameter may be used to adjust the scale of VLM scores 275 relative to the detection scores 240 in Eqn. 2. In the special case when the region b is equal to an entire input image 205, the VLM scores 275, denoted as w(v_{b}), become equivalent to zero-shot image classification scores.

Despite not being trained on regions, the cropped region features of [symbol] (.) maintain high open-vocabulary recognition ability. However, in some embodiments, the cropped region features may not be sufficiently sensitive to the localization quality of the regions, for example, a loosely vs. tightly localized box may both include similar features. Although this may benefit classification, it may pose challenges for detection because it is desirable for the detection scores to reflect localization quality as well. To remedy this, a geometric mean 280 may be applied to combine the VLM scores 275, denoted as w(v_{b})ᵢ in Eqn. 4, with the detection scores 240, denoted as z(r_{b})ᵢ in Eqn. 2, for each region b and category i. The open-vocab detection scores 285, denoted as s (r_{b})ᵢ may be determined as:

$${s ( {r}_{b} )}_{i} = \{ \begin{matrix}z {( {r}_{b} )}_{i}^{( 1 - α )} \cdot {w ( {v}_{b} )}_{i}^{α} if i ∈ {C}_{B} \\ z {( {r}_{b} )}_{i}^{( 1 - β )} \cdot {w ( {v}_{b} )}_{i}^{β} if i ∈ {C}_{N}\end{matrix} \qquad ( Eqn . 5 )$$

where α, β∈[0,1] are tunable parameters that control VLM score weights for base and/or novel categories, and the background score may be received directly from the detector head 215 to obtain s (r_{b})₀=z(r_{b})₀. Compared to an ensemble system, the F-VLM design described herein is simple and does not depend on knowledge distillation and/or double Faster R-CNN heads.

### Open-Vocabulary Localization

Localizing and separating novel objects from a background is a challenging problem in open-vocabulary detection. Standard detectors are generally not designed for localizing novel objects because such models apply class-specific localization, including box regression and mask prediction heads, such as, for example, Mask R-CNN. As described herein, class-agnostic box regression and mask prediction heads may be used instead. In some embodiments, for each region proposal 220, one box and one mask may be predicted for base and novel categories, rather than one box and one mask per category. Such a simple change enables localization of novel objects in the open-vocabulary settings. Generally, the F-VLM framework may not be specific to a choice of a Mask R-CNN detector head, and other models may be applied as well.

### Experiments: Example Implementation Details

For illustrative purposes, the detector head 115 (resp. detector head 215) may be chosen to be a Mask R-CNN with a feature pyramid network. In some embodiments, the model may be trained for 46.1k iterations with 1024×1024 image size, large scale jittering, batch size 256, weight decay 1e-4, momentum 0.9, and an initial learning rate 0.36. For the score combination, α=0.35 and β=0.65 in Eqn. 5. A maximum of 300 detections per image may be used, and set the temperature T=0.01 in Eqn. 4. Also, for example, CLIP prompt templates may be used along with average text embeddings of each category.

### Experiments: Open-Vocabulary Detection Benchmark

### LVIS Benchmark

The models may be evaluated on the LVIS dataset which includes a large and diverse set of 1903 object categories suitable for open-vocabulary detection. In some embodiments, frequent and common categories may be used as the base categories C_{B} for training, and rare categories may be used as the novel categories Cy for testing. The benchmark may be based on the metric mask APT. To ensure reproducibility, the mean of five (5) independent runs may be determined. For a fair comparison, the same Mask R-CNN head architecture used in existing models may be used, and a similar large scale jittering recipe may be used as well.

FIG. 3 is a table 300 illustrating comparisons between various object detection models, in accordance with example embodiments. F-VLM outperforms the best existing approach by 6.5 mask Average Precision (AP) on novel categories. The methods may use the same instance-level supervision from LVIS base categories, CLIP pre-training, and fixed prompt templates. In some embodiments, prompt optimization may be used to improve upon fixed prompt templates. FIG. 3 presents results on LVIS. In the R50 comparisons, F-VLM ranks second among the alternatives based on knowledge distillation, pre-training, and/or joint training with weak supervision. The DetPro model displays the effectiveness of prompt optimization that may, in some embodiments, be applied to F-VLM. In the system-level comparison, the performance of F-VLM scales up with frozen model capacity, even though the amount of trainable parameters may remain fixed. One experimental F-VLM model may achieve 32.8 APT, which is +14.2 April from the R50 baseline, which appears to be a significant improvement on known results on this benchmark. The F-VLM model outperforms VILD-EN-B7 by 6.5 mask APr on the novel categories (and +5.6 overall mask AP).

### COCO Benchmark

Many existing works on zero-shot detection and open-vocabulary detection benchmark on COCO. The COCO vocabulary may be divided into 48 base categories for training and 17 novel categories for testing. Results are reported in generalized detection settings without instance segmentation. The metric AP50 of novel categories may be used. Similar to LVIS, the mean of five (5) independent runs may be computed to ensure reproducibility.

Due to the smaller number of training categories, there may be a tendency to overfit when the same LVIS training recipe is re-used. F-VLM does not rely on additional objectives, such as, for example, knowledge distillation or weak supervision to counter-balance overfitting. Therefore to mitigate this, in some embodiments, the training epoch, and background weight may be reduced, and the weight decay may be increased.

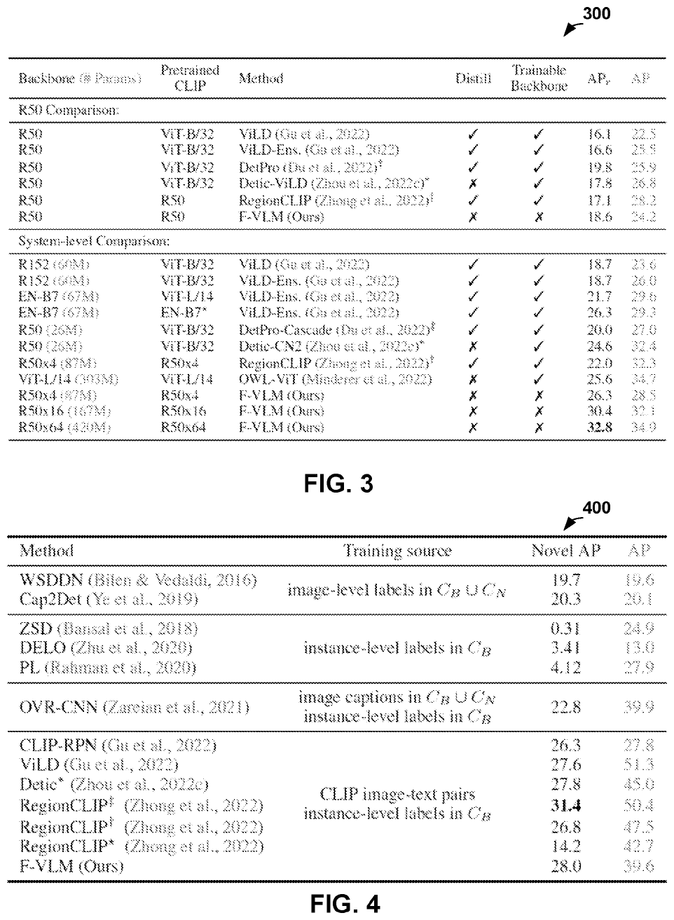

FIG. 4 is a table 400 illustrating comparisons between various object detection models, in accordance with example embodiments. As illustrated, F-VLM is competitive with the other methods trained with various sources. The methods use the ResNet50 backbone. RegionCLIP additionally uses COCO Captions or CC3M for pre-training. F-VLM directly uses a frozen CLIP backbone. F-VLM appears to significantly surpass the CLIP-R50 pre-trained version of RegionCLIP, which does not leverage pre-training on caption data. Compared to other approaches, F-VLM appears to offer better performance without the use of detection-tailored pre-training, weakly supervised learning, and/or knowledge distillation.

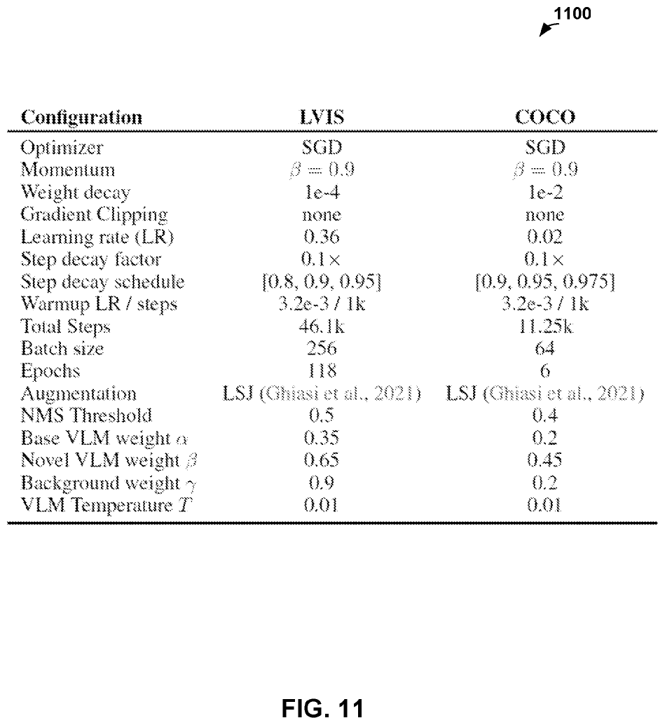

FIG. 11 is a table 1100 summarizing example hyper-parameters for LVIS and COCO benchmarking, in accordance with example embodiments. On LVIS, the same hyper-parameters as existing models may be adopted, except for a shorter schedule (due to frozen backbone) and a background weight. The hyper-parameter differences on COCO may be introduced to mitigate overfitting to the ZSD-COCO split of 48 categories, which is significantly smaller than the 800 LVIS base categories. F-VLM does not use other objectives, such as, for example, knowledge distillation or weak supervision to counter-balance overfitting, and therefore the hyper-parameter differences may be acceptable.

Some differences in the optimal hyper-parameters for different backbone architectures may be observed. With the R50×64 backbone, there may be an improvement of 1.0 APr when we T=0.02 as opposed to the default T=0.01. For and R50 backbone, an improvement of 0.5 APT may be observed when a gradient clipping of 1.0 maximum gradient norm is applied as opposed to none.

### Training Resource Benchmark

Frozen VLMs may also facilitate training resource savings. The benchmark may be based on the ViLD model as it is generally comparable to F-VLM. Both models adopt the same Mask R-CNN head configuration and training recipe, and neither model depends on detection-tailored pre-training. For ViLD, the training cost on TPUv3 cores on the same batch size may be compared. The data about ViLD training time and resource use may be obtained directly publicly. To keep the benchmark simple, the pre-trained VLMs are assumed to be given and their training costs may be excluded from the comparison. For F-VLM, the R50×64 backbone may be used and the average over five (5) independent runs may be determined.

FIG. 6 is a table 600 illustrating example results for performance and training cost trade-off, in accordance with example embodiments. LVIS mask APr values are illustrated to demonstrate a trade-off between performance and training cost. Table 600 shows that F-VLM can achieve top performance with much less computation. Compared to the VILD-EN-B7 model at system level, F-VLM appears to achieve better performance with 7.4 epochs of training, which is 226× more compute-efficient and 57× faster in wall clock time. The efficiency gain generally stems from the frozen backbone, which substantially simplifies the learning process. Apart from resource savings, F-VLM also provides substantial memory savings at training time by running the backbone in inference mode. In some embodiments, the F-VLM system runs almost as fast as a standard detector at inference time, because the only addition is a single attention pooling layer on the detected region features (see FIG. 2).

### Transfer Detection Benchmark

F-VLM may be evaluated as a general-purpose detector for different data sources with a view to move towards non dataset-specific detection. F-VLM trained on one dataset may be directly applied to another by swapping out the vocabulary without any fine-tuning, such as, for example, replacing the 1903 LVIS categories with COCO 80 categories. The models may be trained on LVIS base categories and tested on COCO and Objects365-v1 validation splits following a transfer setup of VILD. Since COCO and Objects365 have smaller vocabularies than LVIS, category and image overlaps may be difficult to avoid. The vocabulary overlap between COCO/Objects365 and LVIS base categories may be shown to be 91% and 63% respectively.

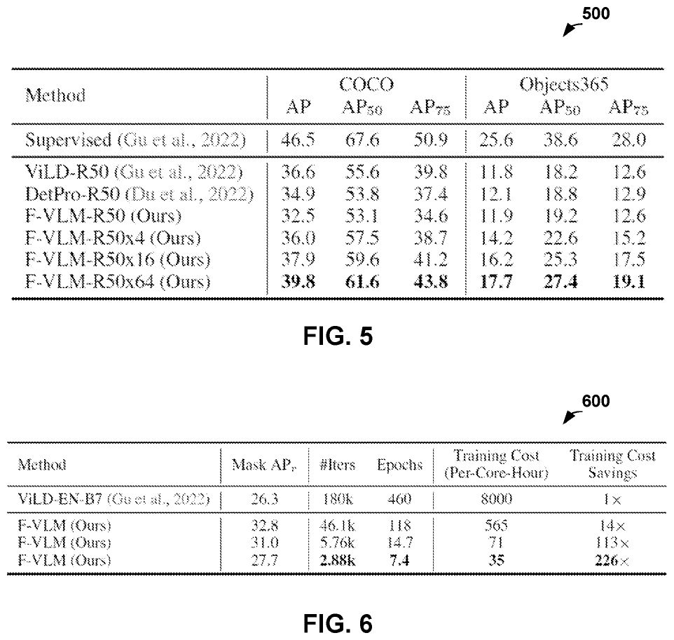

FIG. 5 is a table 500 illustrating example results on various test datasets, in accordance with example embodiments. For example, generalization ability of the detector trained with F-VLM on LVIS may be evaluated on COCO and Object365 datasets. The results reported in Box AP averaged over 5 runs. The performance of F-VLM appears to improve steadily as the frozen model capacity is scaled up. On Objects365/COCO, the F-VLM outperforms existing works ViLD by +3.2/+5.9 and DetPro by +4.9/+5.6, closing the gap with a supervised model on COCO (—33%) and Objects365 (−40%). There does not appear to be a distinction between base and novel categories in the transfer setting, so all categories may be considered as novel. Also, for example, β alone may be used to combine detection and VLM scores in Eqn. 5. Also, it appears that only the detection scores are needed (B=0) for COCO, while the optimal β=0.3 to 0.4 on Objects365. F-VLM can demonstrate strong scaling property with a gain of +7.3/+5.8 AP on COCO/Objects365 by increasing backbone capacity.

### Ablations

Ablation studies on backbone fine-tuning, score fusion design/parameters, feature pyramid capacity, and background weight are provided below.

### Fine-Tuning

In the exploration of fine-tuning vs frozen backbone (see table 800A), it appears that fine-tuning improves the standard detection (base categories) but may slightly degrade the open-vocabulary detection (novel categories).

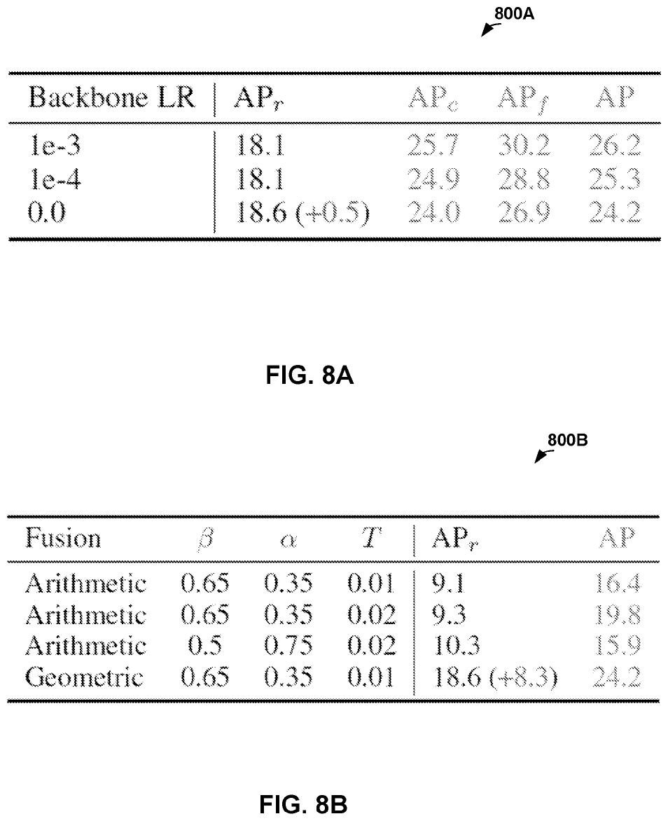

FIG. 8A is a table 800A illustrating example results for VLM-score weights for novel classes, in accordance with example embodiments. The results for pros and cons of backbone fine-tuning compared to the frozen backbone are displayed. Generally, fine-tuning the backbone with the same training recipe can diverge, and gradient clipping (max norm=1.0) may be applied to reduce the backbone learning rate significantly. Table 800A shows that although fine-tuning can benefit the base categories, it may slightly compromise the novel category with higher memory and/or compute footprint.

### Score Fusion

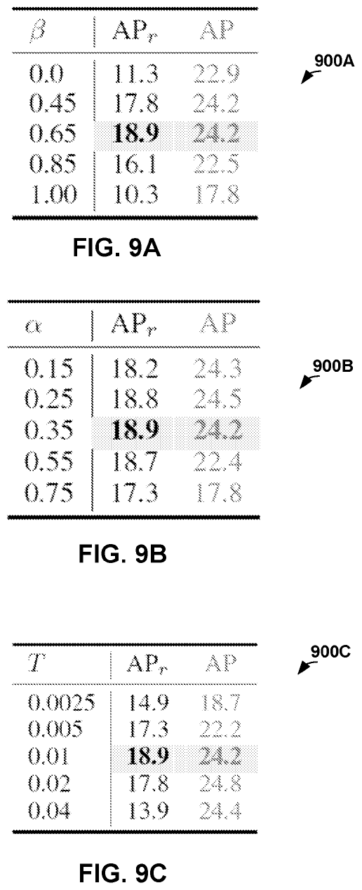

FIG. 8B is a table 800B illustrating example results for the use of arithmetic vs. geometric means to fuse the VLM and detection scores, in accordance with example embodiments. In the score fusion studies (see table 800B), geometric mean appears to be significantly better than the arithmetic mean (+8 April). It is likely because the geometric mean requires a high-scoring region to have good detection and VLM scores simultaneously, whereas the arithmetic mean may favor regions with high detection or VLM scores. A dense grid sweep over a, β can confirm the 8-point gap between geometric and arithmetic means still holds. A more in-depth study of score fusion parameters may be performed with results displayed in FIGS. 9A-C. From the table, we see that β is the main tunable parameter of our model, and the performance is relatively robust to α. For most practical use cases, a setting T=0.01 may be recommended. The temperature t in Eqn. 2 may be learned automatically and does not need to be tuned.

FIGS. 9A-C display tables 900A-C illustrating score fusion parameters, in accordance with example embodiments. In Table 900A and Table 900B, results of score fusion weights are displayed. It appears that observe that β=0.65 and α=0.35 may be beneficial parameter values. Neither detection scores nor VLM scores alone are sufficient as β=0.1 both yield sub-optimal performances. In Table 900C, the temperature in Eqn. 4 is studied and the optimal value appears to be T=10-2, which is generally smaller than the value of learnable parameter τ≈1.0 at the end of training (see Eqn. 2). This generally highlights a need to use a separate T for VLM scores instead of using τ for both detection scores and VLM scores.

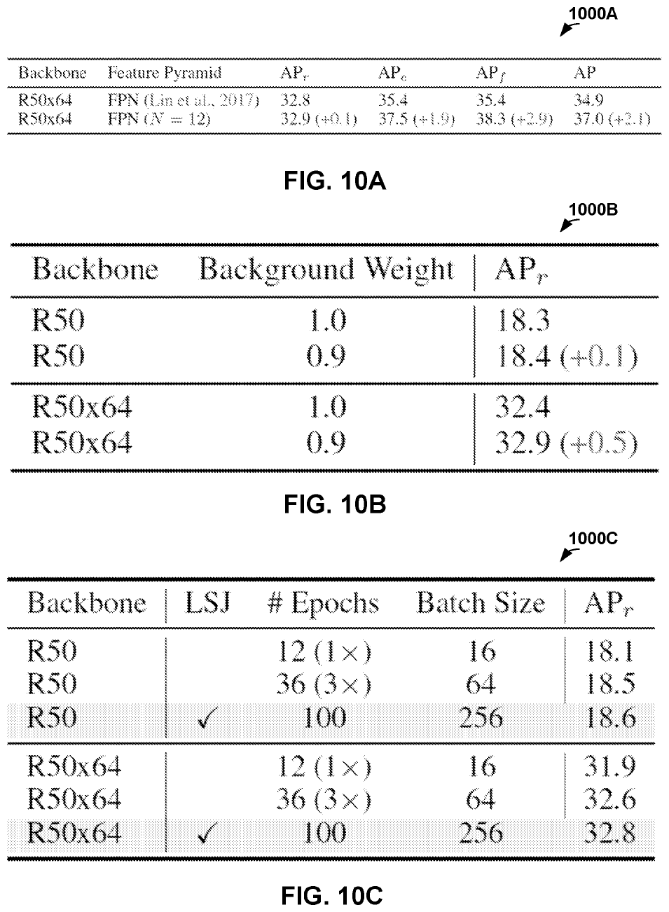

FIG. 10A displays example table 1000A illustrating feature pyramid capacity, in accordance with example embodiments. In table 1000A, the results of the effects of increasing feature pyramid capacity to enhance the representation learned upon the frozen backbone features are illustrated. A larger feature pyramid appears to improve the base categories (APc, APf) without compromising the novel categories (APr). Generally, a larger pyramid benefits standard detection (base categories) without compromising the open-vocabulary detection (novel categories).

FIG. 10B displays example table 1000B illustrating effects of background weights on open-vocabulary detection, in accordance with example embodiments. In Table 1000B, the influence of background weights on open-vocabulary detection are illustrated and background weights appear to have some benefits (e.g., 0.1 to 0.5 April). For example, table 1000B illustrates that a background weight of 0.9 is slightly better than the default 1.0. Therefore, a background weight 0.9 may be used as a default. Results may be averaged over three ((3) independent runs.

### Detection Visualization

FIG. 7 illustrates examples of object detection tasks on various images 700, in accordance with example embodiments. First column C1 and second column C2 display images for open-vocabulary detection on LVIS novel categories. Novel categories detected include fedora, martini, pennant, and football helmet. Third column C3 and fourth column C4 display images for transfer detection on Objects365. Novel categories detected include camel, slide, and goldfish. Fifth column C5 and sixth column C6 display images for transfer detection on Ego4D, a real-world ego-centric application. Novel categories detected include exit sign, recycle bin, window, soy sauce, wooden basket, cereal, bag of cookies, instant noodle, salad dressing, and ketchup. Despite the large domain shift, F-VLM is able to detect many novel and common objects.

### Computation-Friendly Training

To facilitate comparison with the broader research community, the efficacy of F-VLM may be validated in more computation-friendly 1×(12 epochs) and 3×(36 epochs) settings by using a smaller batch size and no large-scale-jittering (LSJ) augmentation.

FIG. 10C displays example table 1000C illustrating benchmark on computation-friendly training, in accordance with example embodiments. Table 1000C illustrates that by leveraging frozen backbone, F-VLM is robust to a shorter schedule and smaller batch size. All results are reported as the average over five (5) runs.

F-VLM appears to be robust to the number of training epochs, batch size, with or without LSJ for both the smallest and largest backbones. This stands in contrast to the sensitivity of fully supervised learning to these hyper-parameters, and is consistent with the results in table 600 of FIG. 6 that frozen backbone contributes to the training efficiency and stability.

### Structure of Frozen Features

To understand the effectiveness of F-VLM, k-means clustering may be performed to probe the structures present in the frozen VLM features (e.g. CLIP). A CLIP R50×4 backbone and LVIS dataset may be used for visualization. In some embodiments, the last layer output features may be used for clustering, because these features may be used for zero-shot region classification at the same time.

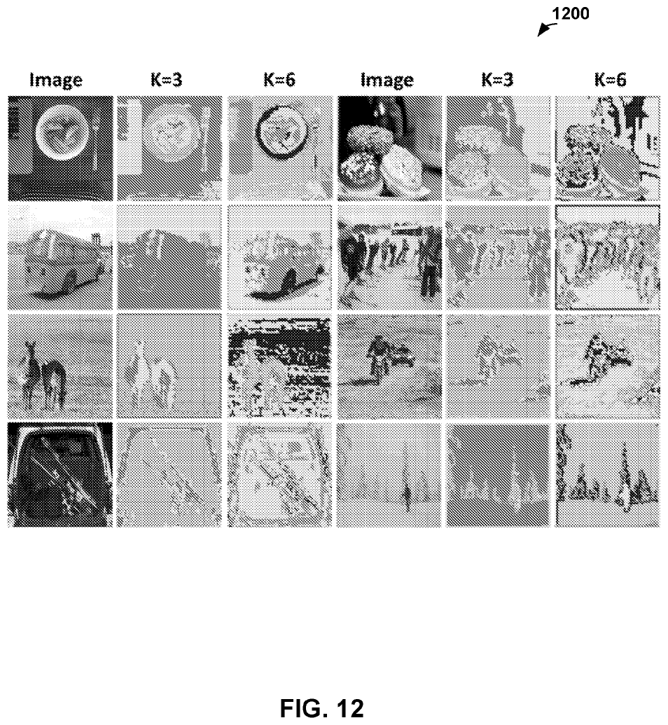

FIG. 12 illustrates examples of F-VLM feature clusters, in accordance with example embodiments. Salient objects and object parts emerge naturally from the clustering of frozen VLM features. As illustrated, the features appear to form clusters around salient objects of the scenes (e.g., skis, motorbikes, people), and naturally separate object parts (e.g., donut toppings, bus wheels) without explicit supervision.

### Transfer Detection Benchmark

Simple name matching shows overlap, while the removal of near duplicates (e.g. synonyms and non-alphabetic character removal) reveals more overlap. In addition, it appears that COCO has more overlap than Objects365 due to its smaller vocabulary.

### Memory Use

The memory consumption of F-VLM can be comparable to Mask R-CNN, with class-specific heads changed to class-agnostic. Moreover, F-VLM has significant memory saving potential compared to existing approaches that fine-tune the backbone, especially with large backbones. At training time, F-VLM does not need to store forward-pass activations, gradients or gradient moments, and the memory use of the backbone is just the backbone weights and a small amount of current activations. This makes F-VLM highly memory efficient especially with large backbones. In practice, the actual memory use depends on the low-level implementation of each deep learning library.

### Alternative Example VLMs

As described herein, CLIP is used to develop a simple open-vocabulary detection recipe based on frozen backbones. Additional, and/or alternative pre-trained VL models e.g. multimodal encoder, captioning model, masked image/language models, may be used. For example, ViT-based pre-trained VLMs may be used. These VLMs require single-scale ViT-based detectors such as ViTDet to adapt them for open-vocabulary detection. To use VLMs like ALBEF and BLIP, an efficient determination of all-pair region-text similarities with multimodal encoders (as opposed to dual encoders) may be determined.

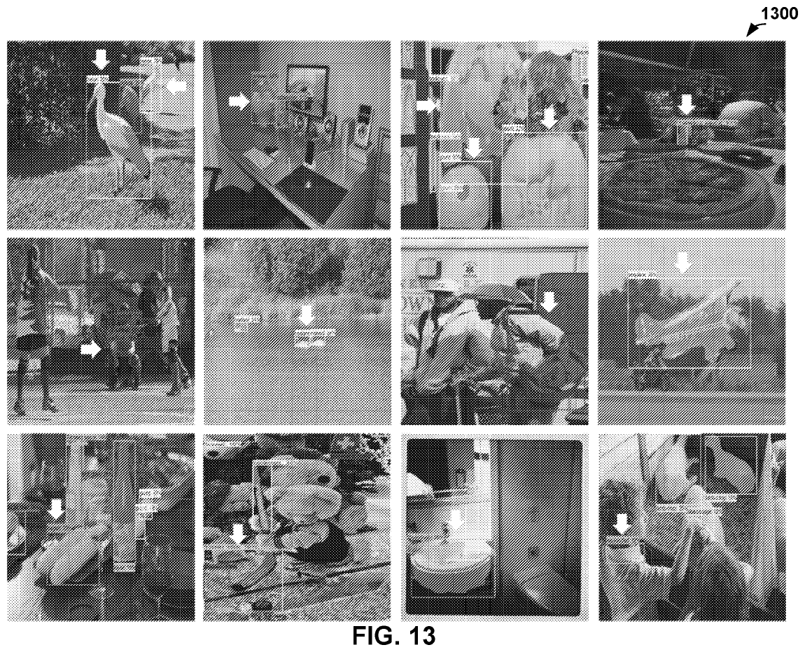

FIG. 13 illustrates examples of LVIS novel category detection, in accordance with example embodiments. F-VLM can detect many novel categories despite its simplicity using a frozen VLM. The white arrows point to the novel objects correctly detected by F-VLM.

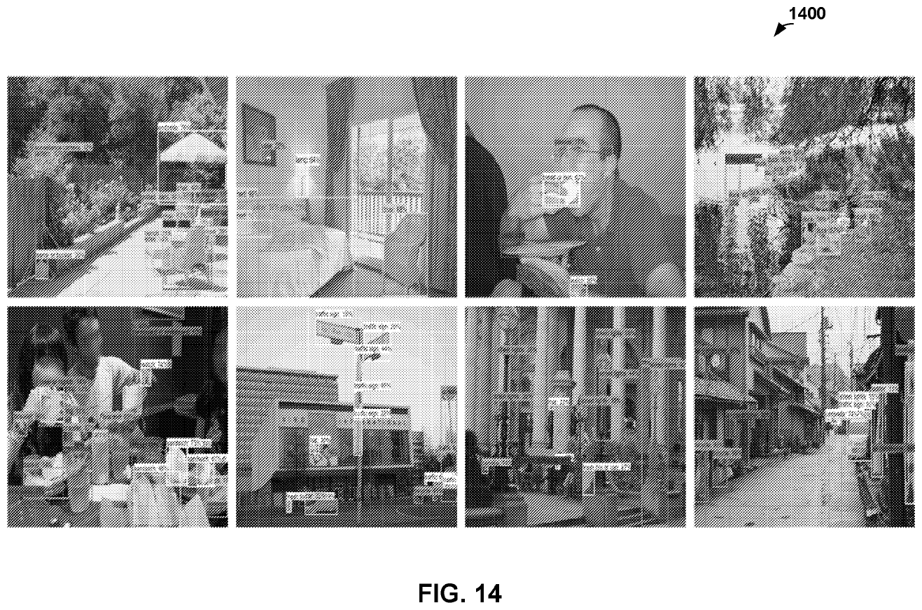

FIG. 14 illustrates examples of Objects365 transfer object detection, in accordance with example embodiments. F-VLM can be applied to a new dataset and detect many challenging categories without further fine-tuning.

### Application on Ego-Centric Data

Among the advantages of open-vocabulary detection is to test on out-of-distribution data with categories given by users on the fly. Thus, F-VLM may be applied to Ego4D, a real-world ego-centric application. F-VLM may be trained on a mixture of full LVIS, Objects365, and COCO datasets to expand its training vocabulary for application in the wild, and the R50×16 backbone may be used. The model may not be trained on Ego4D in order to evaluate it for transfer detection. The categories may be provided by the user based on visual inspection of the video.

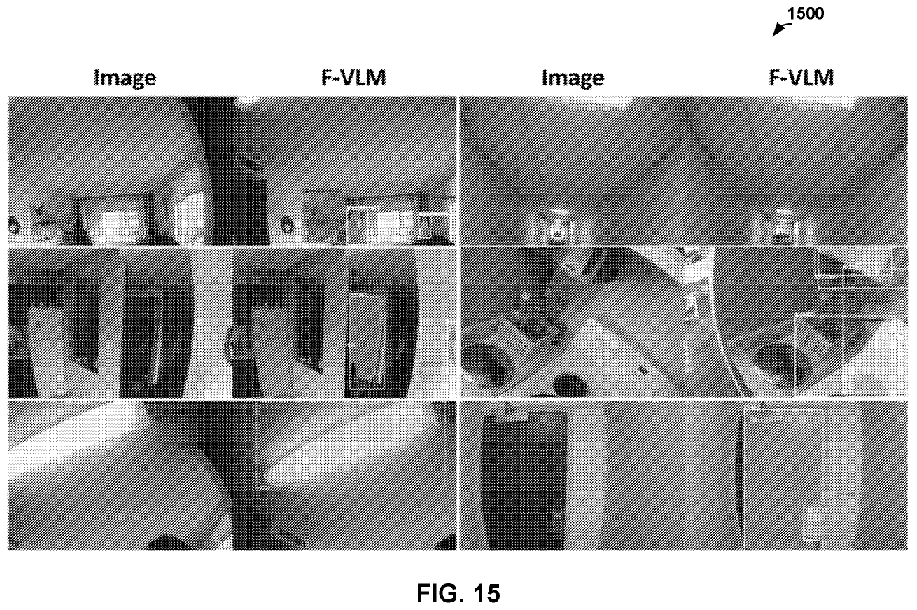

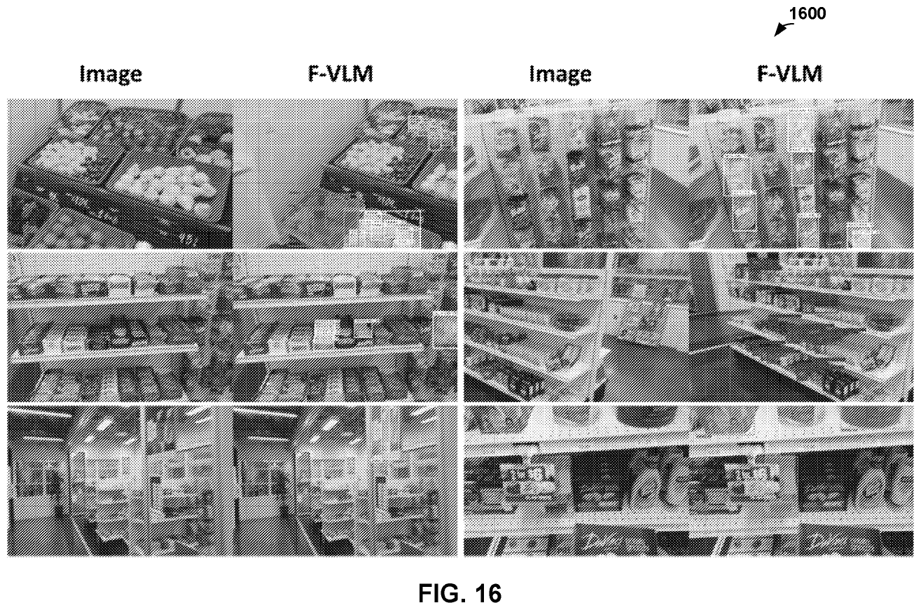

Generally, F-VLM may be able to detect many objects in the ego-centric videos despite the large domain shift and challenging viewing conditions. In particular, F-VLM may be able to detect novel categories not present in the training set, such as a light switch, light, door lock, sauce and seasoning, bag of candies, canned food, and burrito, as illustrated in FIGS. 15 and 16 below.

FIG. 15 illustrates examples of object detection in an indoor scene, in accordance with example embodiments. As illustrated, even under challenging viewing angles, occlusion, and lighting conditions, F-VLM detects many objects in the scene. For the indoor scene, the category names provided by the user are as follows: plate, cabinet, stove, towel, cleaning rag, ventilator, knob, sauce and seasoning, steel lid, window, window blinds, plant, light switch, light, door, carpet, exit sign, doormat, hair, door lock, tree, poster on the wall, sticker on the wall, faucet, recycle bin, rack, hand, can, carton, trash, Christmas tree, plastic container, fridge.

FIG. 16 illustrates examples of object detection in a grocery store scene, in accordance with example embodiments. The scene is very crowded with a wide variety of objects. However, F-VLM is able to detect many of the objects. For the grocery store scene, the category names provided by the user are as follows: exit sign, poster, chocolate bar, bag of candy, bag of cookies, snack, oreo, soy sauce, apple, pear, orange, grapes, price tag, cereal, instant noodle/ramen, cracker, ATM machine, instant noodle, wooden basket, red ramen bowls, magazine, drugs and medicine, Mayo, Ketchup, Cup noodle, burrito, Lays/Sun chips, seasoning sauce, black carton, salad dressing, canned food.

### Example Applications

In one aspect, the input data for object detection comprises image data. Accuracy of object detection performed by an F-VLM based detector head is generally higher than that of other models. The models described herein can perform open-vocabulary object detection and can be used to detect a wide range of objects, and accurately capture many novel objects. For example, F-VLM can detect many long-tail categories without fine tuning.

In some embodiments, a pre-trained vision and language model can be acquired, and a detector head can be added and trained for object detection. Also, for example, the model can be used to localize novel objects in open-vocabulary settings. As another example, F-VLM trained on one dataset can be directly applied to another by swapping out the vocabulary without any fine-tuning.

In some embodiments, the model can reside on a mobile device and perform object detection. Also, for example, the model can analyze video data rather than image data for the purposes of open tracking (track object when entering/leaving the frame and/or specific locations within the frame), anomaly detection (for security/surveillance tracking), and/or segmentation. The detected categories can be linked to features from other datasets, including locations, contacts, dates and/or searches.

The techniques can be applied to object detection in robotic vision, autonomous and semi-autonomous driving, intelligent cameras, security and/or surveillance cameras, satellite image processing, space exploration, and so forth. Also, for example, in applications to autonomous and semi-autonomous driving, the techniques can be applied to object detection during point cloud processing of videos and still images.

As another example, F-VLM including open-vocabulary detection may be applied to product images. For example, the F-VLM models may be applied to shopping images (e.g., product-focused) and Lens images (e.g., from mobile platforms).

These and other example applications are contemplated within a scope of this disclosure.

### Training Machine Learning Models for Generating Inferences/Predictions

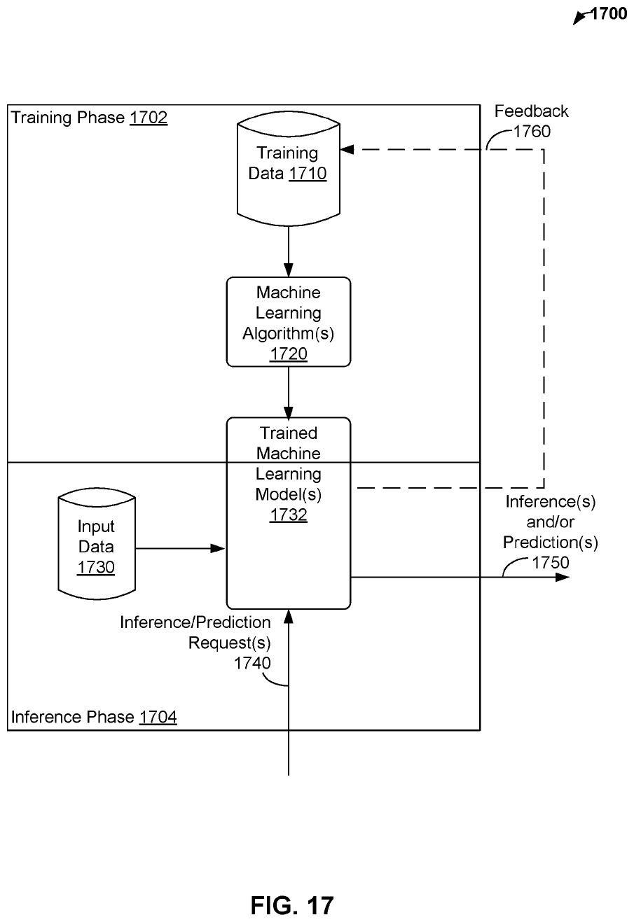

FIG. 17 shows diagram 1700 illustrating a training phase 1702 and an inference phase 1704 of trained machine learning model(s) 1732, in accordance with example embodiments. Some machine learning techniques involve training one or more machine learning algorithms on an input set of training data to recognize patterns in the training data and provide output inferences and/or predictions about (patterns in the) training data. The resulting trained machine learning algorithm can be termed as a trained machine learning model. For example, FIG. 17 shows training phase 1702 where one or more machine learning algorithms 1720 are being trained on training data 1710 to become trained machine learning model(s) 1732. Then, during inference phase 1704, trained machine learning model(s) 1732 can receive input data 1730 and one or more inference/prediction requests 1740 (perhaps as part of input data 1730) and responsively provide as an output one or more inferences and/or prediction(s) 1750.

As such, trained machine learning model(s) 1732 can include one or more models of one or more machine learning algorithms 1720. Machine learning algorithm(s) 1720 may include, but are not limited to: an artificial neural network (e.g., a herein-described convolutional neural networks, a recurrent neural network, a Bayesian network, a hidden Markov model, a Markov decision process, a logistic regression function, a support vector machine, a suitable statistical machine learning algorithm, and/or a heuristic machine learning system). Machine learning algorithm(s) 1720 may be supervised or unsupervised, and may implement any suitable combination of online and offline learning.

In some examples, machine learning algorithm(s) 1720 and/or trained machine learning model(s) 1732 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 1720 and/or trained machine learning model(s) 1732. In some examples, trained machine learning model(s) 1732 can be trained, be resident on, and executed, to provide inferences on a particular computing device, and/or otherwise can make inferences for the particular computing device.

During training phase 1702, machine learning algorithm(s) 1720 can be trained by providing at least training data 1710 as training input using unsupervised, supervised, semi-supervised, and/or reinforcement learning techniques. Unsupervised learning involves providing a portion (or all) of training data 1710 to machine learning algorithm(s) 1720 and machine learning algorithm(s) 1720 determining one or more output inferences based on the provided portion (or all) of training data 1710. Supervised learning involves providing a portion of training data 1710 to machine learning algorithm(s) 1720, with machine learning algorithm(s) 1720 determining one or more output inferences based on the provided portion of training data 1710, and the output inference(s) are either accepted or corrected based on correct results associated with training data 1710. In some examples, supervised learning of machine learning algorithm(s) 1720 can be governed by a set of rules and/or a set of labels for the training input, and the set of rules and/or set of labels may be used to correct inferences of machine learning algorithm(s) 1720.

Semi-supervised learning involves having correct results for part, but not all, of training data 1710. During semi-supervised learning, supervised learning is used for a portion of training data 1710 having correct results, and unsupervised learning is used for a portion of training data 1710 not having correct results. Reinforcement learning involves machine learning algorithm(s) 1720 receiving a reward signal regarding a prior inference, where the reward signal can be a numerical value. During reinforcement learning, machine learning algorithm(s) 1720 can output an inference and receive a reward signal in response, where machine learning algorithm(s) 1720 are configured to try to maximize the numerical value of the reward signal. In some examples, reinforcement learning also utilizes a value function that provides a numerical value representing an expected total of the numerical values provided by the reward signal over time. In some examples, machine learning algorithm(s) 1720 and/or trained machine learning model(s) 1732 can be trained using other machine learning techniques, including but not limited to, incremental learning and curriculum learning.

In some examples, machine learning algorithm(s) 1720 and/or trained machine learning model(s) 1732 can use transfer learning techniques. For example, transfer learning techniques can involve trained machine learning model(s) 1732 being pre-trained on one set of data and additionally trained using training data 1710. More particularly, machine learning algorithm(s) 1720 can be pre-trained on data from one or more computing devices and a resulting trained machine learning model provided to computing device CD1, where CD1 is intended to execute the trained machine learning model during inference phase 1704. Then, during training phase 1702, the pre-trained machine learning model can be additionally trained using training data 1710, where training data 1710 can be derived from kernel and non-kernel data of computing device CD1. This further training of the machine learning algorithm(s) 1720 and/or the pre-trained machine learning model using training data 1710 of CD1's data can be performed using either supervised or unsupervised learning. Once machine learning algorithm(s) 1720 and/or the pre-trained machine learning model has been trained on at least training data 1710, training phase 1702 can be completed. The trained resulting machine learning model can be utilized as at least one of trained machine learning model(s) 1732.

In particular, once training phase 1702 has been completed, trained machine learning model(s) 1732 can be provided to a computing device, if not already on the computing device. Inference phase 1704 can begin after trained machine learning model(s) 1732 are provided to computing device CD1.

During inference phase 1704, trained machine learning model(s) 1732 can receive input data 1730 and generate and output one or more corresponding inferences and/or prediction(s) 1750 about input data 1730. As such, input data 1730 can be used as an input to trained machine learning model(s) 1732 for providing corresponding inference(s) and/or prediction(s) 1750 to kernel components and non-kernel components. For example, trained machine learning model(s) 1732 can generate inference(s) and/or prediction(s) 1750 in response to one or more inference/prediction requests 1740. In some examples, trained machine learning model(s) 1732 can be executed by a portion of other software. For example, trained machine learning model(s) 1732 can be executed by an inference or prediction daemon to be readily available to provide inferences and/or predictions upon request. Input data 1730 can include data from computing device CD1 executing trained machine learning model(s) 1732 and/or input data from one or more computing devices other than CD1. For example, input data 1730 can include a collection of images provided by one or more sources, and text labels for objects in the images. Other types of input data are possible as well.

Inference(s) and/or prediction(s) 1750 can include output images, output intermediate images, numerical values, and/or other output data produced by trained machine learning model(s) 1732 operating on input data 1730 (and training data 1710). In some examples, trained machine learning model(s) 1732 can use output inference(s) and/or prediction(s) 1750 as input feedback 1160. Trained machine learning model(s) 1732 can also rely on past inferences as inputs for generating new inferences.

A neural network comprising a frozen VLM and a trainable detector head can be an example of machine learning algorithm(s) 1720. After training, the trained version of the neural network can be an example of trained machine learning model(s) 1732. In this approach, an example of the one or more inference/prediction request(s) 1740 can be a request to predict an object in an input image and a corresponding example of inferences and/or prediction(s) 1750 can be a predicted object in the input image.

In some examples, one computing device CD_SOLO can include the trained version of the frozen VLM based neural network, perhaps after training. Then, the computing device CD_SOLO can receive a request to predict an object in an input image, and use the trained version of the neural network to predict the object.

In some examples, two or more computing devices CD_CLI and CD_SRV can be used to provide output images; e.g., a first computing device CD_CLI can generate and send requests to predict an object in an input image to a second computing device CD_SRV. Then, CD_SRV can use the trained version of the neural network, to predict the object, and respond to the requests from CD_CLI for the predicted object. Then, upon reception of responses to the requests, CD_CLI can provide the requested predicted object (e.g., using a user interface and/or a display, a printed copy, an electronic communication, etc.).

### Example Data Network

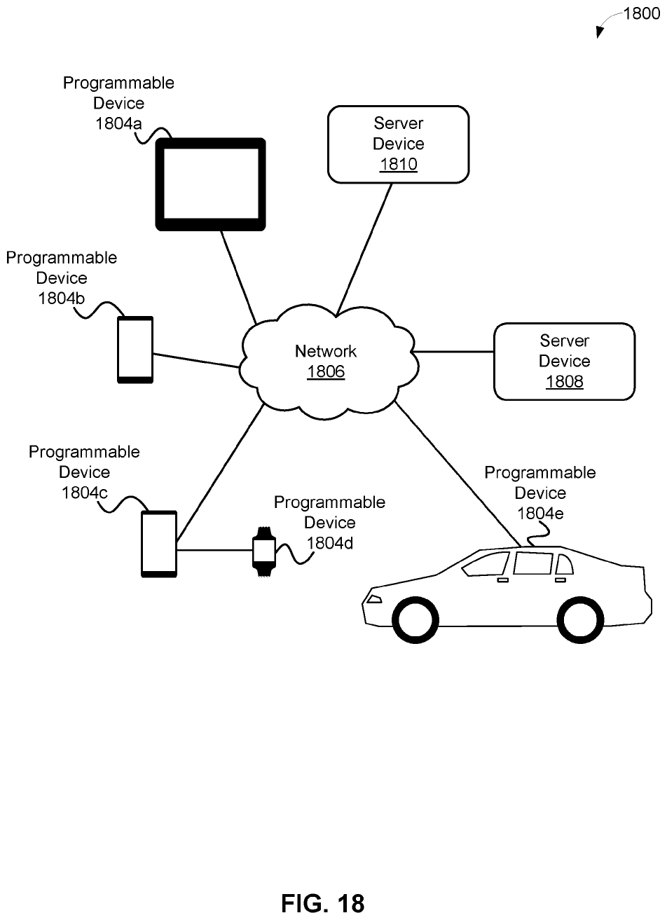

FIG. 18 depicts a distributed computing architecture 1800, in accordance with example embodiments. Distributed computing architecture 1800 includes server devices 1808, 1810 that are configured to communicate, via network 1806, with programmable devices 1804a, 1804b, 1804c, 1804d, 1804e. Network 1806 may correspond to a local area network (LAN), a wide area network (WAN), a WLAN, a WWAN, a corporate intranet, the public Internet, or any other type of network configured to provide a communications path between networked computing devices. Network 1806 may also correspond to a combination of one or more LANs, WANs, corporate intranets, and/or the public Internet.

Although FIG. 18 only shows five programmable devices, distributed application architectures may serve tens, hundreds, or thousands of programmable devices. Moreover, programmable devices 1804a, 1804b, 1804c, 1804d, 1804e (or any additional programmable devices) may be any sort of computing device, such as a mobile computing device, desktop computer, wearable computing device, head-mountable device (HMD), network terminal, a mobile computing device, and so on. In some examples, such as illustrated by programmable devices 1804a, 1804b, 1804c, 1804e, programmable devices can be directly connected to network 1806. In other examples, such as illustrated by programmable device 1804d, programmable devices can be indirectly connected to network 1806 via an associated computing device, such as programmable device 1804c. In this example, programmable device 1804c can act as an associated computing device to pass electronic communications between programmable device 1804d and network 1806. In other examples, such as illustrated by programmable device 1804e, a computing device can be part of and/or inside a vehicle, such as a car, a truck, a bus, a boat or ship, an airplane, etc. In other examples not shown in FIG. 18, a programmable device can be both directly and indirectly connected to network 1806.

Server devices 1808, 1810 can be configured to perform one or more services, as requested by programmable devices 1804a-1804e. For example, server device 1808 and/or 1810 can provide content to programmable devices 1804a-1804e. The content can include, but is not limited to, web pages, hypertext, scripts, binary data such as compiled software, images, audio, and/or video. The content can include compressed and/or uncompressed content. The content can be encrypted and/or unencrypted. Other types of content are possible as well.

As another example, server device 1808 and/or 1810 can provide programmable devices 1804a-1804e with access to software for database, search, computation, graphical, audio, video, World Wide Web/Internet utilization, and/or other functions. Many other examples of server devices are possible as well.

### Computing Device Architecture

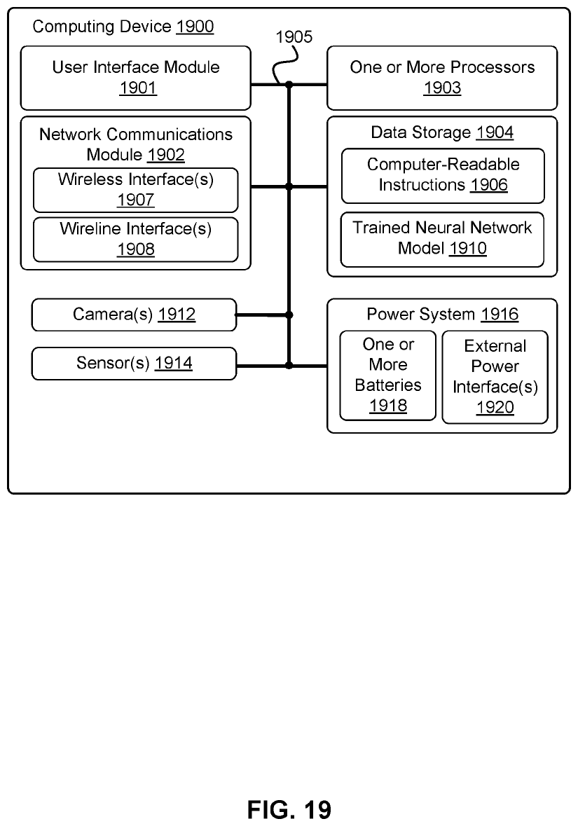

FIG. 19 is a block diagram of an example computing device 1900, in accordance with example embodiments. In particular, computing device 1900 shown in FIG. 19 can be configured to perform at least one function of and/or related to open vocabulary object detection based on a frozen vision and language models, and/or method 1400.

Computing device 1900 may include a user interface module 1901, a network communications module 1902, one or more processors 1903, data storage 1904, one or more camera(s) 1912, one or more sensors 1914, and power system 1916, all of which may be linked together via a system bus, network, or other connection mechanism 1905.

User interface module 1901 can be operable to send data to and/or receive data from external user input/output devices. For example, user interface module 1901 can be configured to send and/or receive data to and/or from user input devices such as a touch screen, a computer mouse, a keyboard, a keypad, a touch pad, a trackball, a joystick, a voice recognition module, and/or other similar devices. User interface module 1901 can also be configured to provide output to user display devices, such as one or more cathode ray tubes (CRT), liquid crystal displays, light emitting diodes (LEDs), displays using digital light processing (DLP) technology, printers, light bulbs, and/or other similar devices, either now known or later developed. User interface module 1901 can also be configured to generate audible outputs, with devices such as a speaker, speaker jack, audio output port, audio output device, earphones, and/or other similar devices. User interface module 1901 can further be configured with one or more haptic devices that can generate haptic outputs, such as vibrations and/or other outputs detectable by touch and/or physical contact with computing device 1900. In some examples, user interface module 1901 can be used to provide a graphical user interface (GUI) for utilizing computing device 1900, such as, for example, a graphical user interface of a mobile phone device.

Network communications module 1902 can include one or more devices that provide one or more wireless interface(s) 1907 and/or one or more wireline interface(s) 1908 that are configurable to communicate via a network. Wireless interface(s) 1907 can include one or more wireless transmitters, receivers, and/or transceivers, such as a Bluetooth™ transceiver, a Zigbee® transceiver, a Wi-Fi™ transceiver, a WiMAX™ transceiver, an LTE™ transceiver, and/or other type of wireless transceiver configurable to communicate via a wireless network. Wireline interface(s) 1908 can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some examples, network communications module 1902 can be configured to provide reliable, secured, and/or authenticated communications. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information such as cyclic redundancy check (CRC) and/or parity check values). Communications can be made secure (e.g., be encoded or encrypted) and/or decrypted/decoded using one or more cryptographic protocols and/or algorithms, such as, but not limited to, Data Encryption Standard (DES), Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure (and then decrypt/decode) communications.

One or more processors 1903 can include one or more general purpose processors, and/or one or more special purpose processors (e.g., digital signal processors, tensor processing units (TPUs), graphics processing units (GPUs), application specific integrated circuits, etc.). One or more processors 1903 can be configured to execute computer-readable instructions 1806 that are contained in data storage 1904 and/or other instructions as described herein.

Data storage 1904 can include one or more non-transitory computer-readable storage media that can be read and/or accessed by at least one of one or more processors 1903. The one or more computer-readable storage media can include volatile and/or non-volatile storage components, such as optical, magnetic, organic or other memory or disc storage, which can be integrated in whole or in part with at least one of one or more processors 1903. In some examples, data storage 1904 can be implemented using a single physical device (e.g., one optical, magnetic, organic or other memory or disc storage unit), while in other examples, data storage 1904 can be implemented using two or more physical devices.

Data storage 1904 can include computer-readable instructions 1806 and perhaps additional data. In some examples, data storage 1904 can include storage required to perform at least part of the herein-described methods, scenarios, and techniques and/or at least part of the functionality of the herein-described devices and networks. In some examples, data storage 1904 can include storage for a trained neural network model 1910 (e.g., a model of trained neural networks such as a vision and language model). In particular of these examples, computer-readable instructions 1806 can include instructions that, when executed by one or more processors 1903, enable computing device 1900 to provide for some or all of the functionality of trained neural network model 1910.

In some examples, computing device 1900 can include one or more camera(s) 1912. Camera(s) 1912 can include one or more image capture devices, such as still and/or video cameras, equipped to capture light and record the captured light in one or more images; that is, camera(s) 1912 can generate image(s) of captured light. The one or more images can be one or more still images and/or one or more images utilized in video imagery. Camera(s) 1912 can capture light and/or electromagnetic radiation emitted as visible light, infrared radiation, ultraviolet light, and/or as one or more other frequencies of light.

In some examples, computing device 1900 can include one or more sensors 1914. Sensors 1914 can be configured to measure conditions within computing device 1900 and/or conditions in an environment of computing device 1900 and provide data about these conditions. For example, sensors 1914 can include one or more of: (i) sensors for obtaining data about computing device 1900, such as, but not limited to, a thermometer for measuring a temperature of computing device 1900, a battery sensor for measuring power of one or more batteries of power system 1916, and/or other sensors measuring conditions of computing device 1900; (ii) an identification sensor to identify other objects and/or devices, such as, but not limited to, a Radio Frequency Identification (RFID) reader, proximity sensor, one-dimensional barcode reader, two-dimensional barcode (e.g., Quick Response (QR) code) reader, and a laser tracker, where the identification sensors can be configured to read identifiers, such as RFID tags, barcodes, QR codes, and/or other devices and/or object configured to be read and provide at least identifying information; (iii) sensors to measure locations and/or movements of computing device 1900, such as, but not limited to, a tilt sensor, a gyroscope, an accelerometer, a Doppler sensor, a GPS device, a sonar sensor, a radar device, a laser-displacement sensor, and a compass; (iv) an environmental sensor to obtain data indicative of an environment of computing device 1900, such as, but not limited to, an infrared sensor, an optical sensor, a light sensor, a biosensor, a capacitive sensor, a touch sensor, a temperature sensor, a wireless sensor, a radio sensor, a movement sensor, a microphone, a sound sensor, an ultrasound sensor and/or a smoke sensor; and/or (v) a force sensor to measure one or more forces (e.g., inertial forces and/or G-forces) acting about computing device 1900, such as, but not limited to one or more sensors that measure: forces in one or more dimensions, torque, ground force, friction, and/or a zero moment point (ZMP) sensor that identifies ZMPs and/or locations of the ZMPs. Many other examples of sensors 1914 are possible as well.

Power system 1916 can include one or more batteries 1918 and/or one or more external power interfaces 1920 for providing electrical power to computing device 1900. Each battery of the one or more batteries 1918 can, when electrically coupled to the computing device 1900, act as a source of stored electrical power for computing device 1900. One or more batteries 1918 of power system 1916 can be configured to be portable. Some or all of one or more batteries 1918 can be readily removable from computing device 1900. In other examples, some or all of one or more batteries 1918 can be internal to computing device 1900, and so may not be readily removable from computing device 1900. Some or all of one or more batteries 1918 can be rechargeable. For example, a rechargeable battery can be recharged via a wired connection between the battery and another power supply, such as by one or more power supplies that are external to computing device 1900 and connected to computing device 1900 via the one or more external power interfaces. In other examples, some or all of one or more batteries 1918 can be non-rechargeable batteries.

One or more external power interfaces 1920 of power system 1916 can include one or more wired-power interfaces, such as a USB cable and/or a power cord, that enable wired electrical power connections to one or more power supplies that are external to computing device 1900. One or more external power interfaces 1920 can include one or more wireless power interfaces, such as a Qi wireless charger, that enable wireless electrical power connections, such as via a Qi wireless charger, to one or more external power supplies. Once an electrical power connection is established to an external power source using one or more external power interfaces 1920, computing device 1900 can draw electrical power from the external power source the established electrical power connection. In some examples, power system 1916 can include related sensors, such as battery sensors associated with the one or more batteries or other types of electrical power sensors.

### Cloud-Based Servers

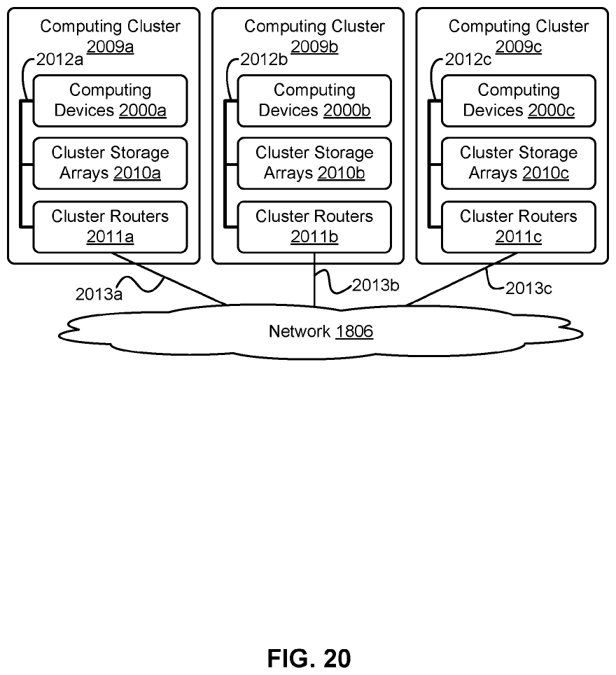

FIG. 20 depicts a cloud-based server system in accordance with an example embodiment. In FIG. 20, functionality of an open vocabulary object detection based on a frozen vision and language model, and/or a computing device can be distributed among computing clusters 2009a, 2009b, 2009c. Computing cluster 2009a can include one or more computing devices 2000a, cluster storage arrays 2010a, and cluster routers 2011a connected by a local cluster network 2012a. Similarly, computing cluster 2009b can include one or more computing devices 2000b, cluster storage arrays 2010b, and cluster routers 2011b connected by a local cluster network 2012b. Likewise, computing cluster 2009c can include one or more computing devices 2000c, cluster storage arrays 2010c, and cluster routers 2011c connected by a local cluster network 2012c.

In some embodiments, computing clusters 2009a, 2009b, 2009c can be a single computing device residing in a single computing center. In other embodiments, computing clusters 2009a, 2009b, 2009c can include multiple computing devices in a single computing center, or even multiple computing devices located in multiple computing centers located in diverse geographic locations. For example, FIG. 20 depicts each of computing clusters 2009a, 2009b, 2009c residing in different physical locations.

In some embodiments, data and services at computing clusters 2009a, 2009b, 2009c can be encoded as computer readable information stored in non-transitory, tangible computer readable media (or computer readable storage media) and accessible by other computing devices. In some embodiments, computing clusters 2009a, 2009b, 2009c can be stored on a single disk drive or other tangible storage media, or can be implemented on multiple disk drives or other tangible storage media located at one or more diverse geographic locations.

In some embodiments, each of computing clusters 2009a, 2009b, and 2009c can have an equal number of computing devices, an equal number of cluster storage arrays, and an equal number of cluster routers. In other embodiments, however, each computing cluster can have different numbers of computing devices, different numbers of cluster storage arrays, and different numbers of cluster routers. The number of computing devices, cluster storage arrays, and cluster routers in each computing cluster can depend on the computing task or tasks assigned to each computing cluster.

In computing cluster 2009a, for example, computing devices 2000a can be configured to perform various computing tasks of a frozen vision and language model based neural network (e.g., detector head), and/or a computing device. In one embodiment, the various functionalities of a neural network, and/or a computing device can be distributed among one or more of computing devices 2000a, 2000b, 2000c. Computing devices 2000b and 2000c in respective computing clusters 2009b and 2009c can be configured similarly to computing devices 2000a in computing cluster 2009a. On the other hand, in some embodiments, computing devices 2000a, 2000b, and 2000c can be configured to perform different functions.

In some embodiments, computing tasks and stored data associated with a neural network, and/or a computing device can be distributed across computing devices 2000a, 2000b, and 2000c based at least in part on the processing requirements of a neural network, and/or a computing device, the processing capabilities of computing devices 2000a, 2000b, 2000c, the latency of the network links between the computing devices in each computing cluster and between the computing clusters themselves, and/or other factors that can contribute to the cost, speed, fault-tolerance, resiliency, efficiency, and/or other design goals of the overall system architecture.

Cluster storage arrays 2010a, 2010b, 2010c of computing clusters 2009a, 2009b, 2009c can be data storage arrays that include disk array controllers configured to manage read and write access to groups of hard disk drives. The disk array controllers, alone or in conjunction with their respective computing devices, can also be configured to manage backup or redundant copies of the data stored in the cluster storage arrays to protect against disk drive or other cluster storage array failures and/or network failures that prevent one or more computing devices from accessing one or more cluster storage arrays.

Similar to the manner in which the functions of a conditioned, axial self-attention based neural network, and/or a computing device can be distributed across computing devices 2000a, 2000b, 2000c of computing clusters 2009a, 2009b, 2009c, various active portions and/or backup portions of these components can be distributed across cluster storage arrays 2010a, 2010b, 2010c. For example, some cluster storage arrays can be configured to store one portion of the data of a first layer of a neural network, and/or a computing device, while other cluster storage arrays can store other portion(s) of data of second layer of a neural network, and/or a computing device. Also, for example, some cluster storage arrays can be configured to store the data of an encoder of a neural network, while other cluster storage arrays can store the data of a decoder of a neural network. Additionally, some cluster storage arrays can be configured to store backup versions of data stored in other cluster storage arrays.

Cluster routers 2011a, 2011b, 2011c in computing clusters 2009a, 2009b, 2009c can include networking equipment configured to provide internal and external communications for the computing clusters. For example, cluster routers 2011a in computing cluster 2009a can include one or more internet switching and routing devices configured to provide (i) local area network communications between computing devices 2000a and cluster storage arrays 2010a via local cluster network 2012a, and (ii) wide area network communications between computing cluster 2009a and computing clusters 2009b and 2009c via wide area network link 2013a to network 1806. Cluster routers 2011b and 2011c can include network equipment similar to cluster routers 2011a, and cluster routers 2011b and 2011c can perform similar networking functions for computing clusters 2009b and 2009b that cluster routers 2011a perform for computing cluster 2009a.

In some embodiments, the configuration of cluster routers 2011a, 2011b, 2011c can be based at least in part on the data communication requirements of the computing devices and cluster storage arrays, the data communications capabilities of the network equipment in cluster routers 2011a, 2011b, 2011c, the latency and throughput of local cluster networks 2012a, 2012b, 2012c, the latency, throughput, and cost of wide area network links 2013a, 2013b, 2013c, and/or other factors that can contribute to the cost, speed, fault-tolerance, resiliency, efficiency and/or other design criteria of the moderation system architecture.

### Example Methods of Operation

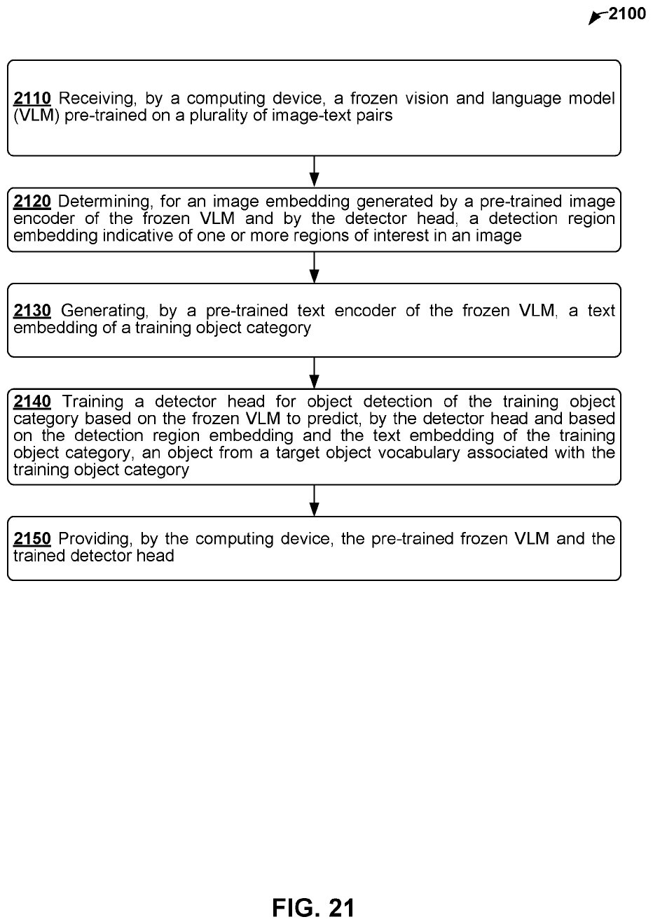

FIG. 21 is a flowchart of a method 2100, in accordance with example embodiments. Method 2100 can be executed by a computing device, such as computing device 1900. Method 2100 can begin at block 2110, where the computing device receives a frozen vision and language model (VLM) pre-trained on a plurality of image-text pairs.

At block 2120, the computing device determines, for an image embedding generated by a pre-trained image encoder of the frozen VLM and by the detector head, a detection region embedding indicative of one or more regions of interest in an image.

At block 2130, the computing device generates, by a pre-trained text encoder of the frozen VLM, a text embedding of a training object category.

At block 2140, the computing device trains a detector head for object detection of the training object category based on a frozen VLM to predict, by the detector head and based on the detection region embedding and the text embedding of the training object category, an object from a target object vocabulary associated with the training object category.

At block 2150, the computing device provides the pre-trained frozen VLM and the trained detector head.

In some embodiments, the predicting of the object involves determining, by the detector head, one or more detection scores for the one or more regions of interest, wherein the one or more detection scores for the one or more regions of interest is indicative of the predicted object.

In some embodiments, the predicting of the object involves training the detector head to predict one or more object detection boxes and associated masks corresponding to the one or more regions of interest, and wherein the one or more detection scores are associated with the one or more predicted object detection boxes.

In some embodiments, the training of the detector head may be based on one or more of a box region loss, a box classification loss, or a mask classification loss.

In some embodiments, the detector head includes a first stage and a second stage, and wherein the determining of the detection region embedding is performed by the first stage, and wherein the determining of the text embedding is performed by the second stage.

In some embodiments, the detector head may be a neural network. In some embodiments, the detector head may be one of a Mask R-CNN or a Faster R-CNN.

In some embodiments, the detector head includes a feature pyramid network.

In some embodiments, the pre-trained text encoder and the pre-trained image encoder of the frozen VLM may be jointly trained based on contrastive learning.

In some embodiments, the pre-trained image encoder includes a (i) feature extractor to generate the image representation for the image, and (ii) a feature pooling layer.

In some embodiments, the feature extractor includes a ResNet-50 architecture.

In some embodiments, the feature pooling layer may be an attention layer of the image encoder.

Some embodiments involve maintaining an image normalization scheme of the pre-trained frozen VLM to enable open vocabulary object detection.

Some embodiments involve receiving, by the computing device, the pre-trained frozen VLM and the trained detector head, the pre-trained frozen VLM having been trained on the collection of image-text pairs of a first dataset, and the detector head having been trained on a first collection of training object categories of the first dataset. Such embodiments involve testing, by the computing device, the detector head on a second dataset comprising a second collection of inference object categories, wherein the testing comprises substituting the first collection of training object categories of the first training dataset with the second collection of inference object categories of the second dataset.

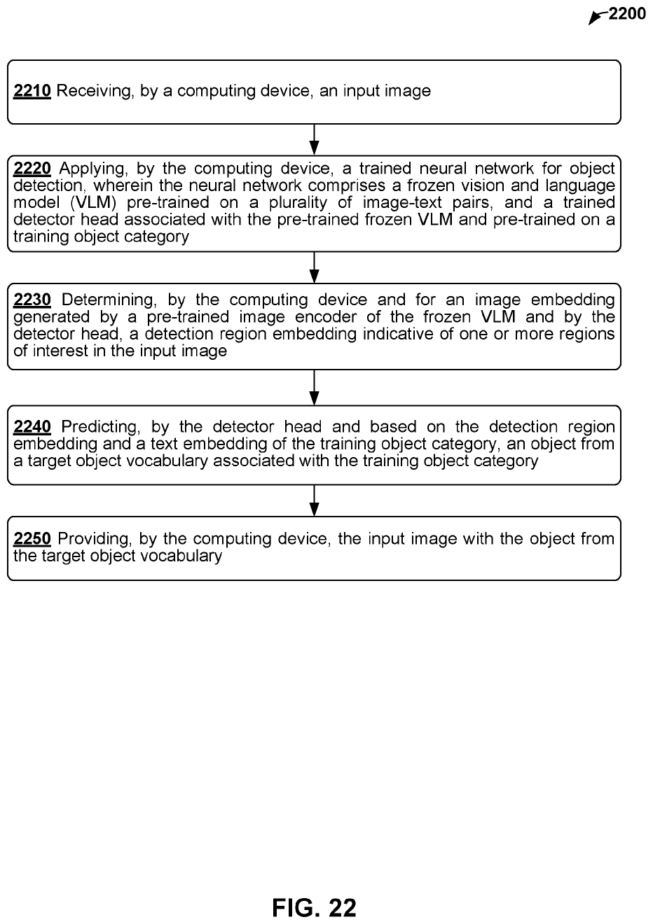

FIG. 22 is a flowchart of a method 2200, in accordance with example embodiments. Method 2200 can be executed by a computing device, such as computing device 1900. Method 2200 can begin at block 2210, where the computing device receives an input image.

At block 2220, the computing device applies a trained neural network for object detection, wherein the neural network comprises a frozen vision and language model (VLM) pre-trained on a plurality of image-text pairs, and a detector head associated with the pre-trained frozen VLM and pre-trained on a training object category.

At block 2230, the computing device determines, for an image embedding generated by a pre-trained image encoder of the frozen VLM and by the detector head, a detection region embedding indicative of one or more regions of interest in the input image.

At block 2240, the computing device predicts, by the detector head and based on the detection region embedding and a text embedding of the training object category, an object from a target object vocabulary associated with the training object category.

At block 2250, the computing device provides the input image with the object from the target object vocabulary.

In some embodiments, the predicting of the object involves determining, by the detector head, one or more detection scores for the one or more regions of interest, wherein the one or more detection scores for the one or more regions of interest is indicative of the predicted object.

In some embodiments, the predicting of the object involves predicting one or more object detection boxes and associated masks corresponding to the one or more regions of interest, and wherein the one or more detection scores are associated with the one or more predicted object detection boxes.

Some embodiments involve providing, by the computing device, the predicted object from the target object vocabulary associated with the training object category.

Some embodiments involve receiving, by the pre-trained text encoder, an inference object category different from the training object category. Such embodiments involve augmenting, by the trained detector head, the text embedding of the training object category with an additional embedding of the inference object category, and wherein the predicting of the object comprises predicting, based on the augmented text embedding and the detection region embedding, an additional object from an augmented target object vocabulary associated with the training object category and the inference object category.

In some embodiments, the predicting of the additional object involves determining, by the trained detector head, one or more augmented detection scores for the one or more regions of interest, wherein the one or more augmented detection scores for the one or more regions of interest is indicative of the predicted additional object.

In some embodiments, the determining of the one or more open vocabulary detection scores involves determining a geometric mean of the one or more augmented detection scores and the one or more VLM scores.

In some embodiments, the pre-trained image encoder includes a feature pooling layer trained to generate one or more VLM region embeddings. Such embodiments involve generating, by the feature pooling layer, one or more VLM scores corresponding to the one or more regions of interest, wherein the one or more VLM scores is based on the one or more VLM region embeddings and the augmented text embedding. Such embodiments also involve determining one or more open vocabulary detection scores corresponding to the one or more regions of interest, wherein the one or more open vocabulary detection scores is based on the one or more augmented detection scores and the one or more VLM scores.

In some embodiments, the feature pooling layer may be an attention layer of the image encoder.

In some embodiments, the detector head may be a neural network. In some embodiments, the detector head may be one of a Mask R-CNN or a Faster R-CNN.

In some embodiments, the detector head may have been trained to perform one-stage object detection.

In some embodiments, the detector head may have been trained to perform two-stage object detection. The determining of the detection region embedding may be performed by a first stage, and the determining of the text embedding may be performed by a second stage.

In some embodiments, the detector head may include a feature pyramid network.

In some embodiments, the pre-trained text encoder and the pre-trained image encoder of the frozen VLM may have been jointly trained based on contrastive learning

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as non-transitory computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

As described herein, new capabilities in detecting previously unseen categories of objects (unseen by the machine learning model), and particularly on challenging benchmarks and transfer settings are described. The described models utilize the information embedded in Vision-Language Models, which may, in some cases, reinforce deficiencies and biases in the internet data, and/or propagate potentially harmful biases and/or stereotypes. Although the example models herein are trained for evaluation and/or benchmark purposes, such models may generally need more rigorous probing for bias, fairness, etc., prior to being used for other purposes.

While various aspects and embodiments have been disclosed herein, other aspects and embodiments will be apparent to those skilled in the art. The various aspects and embodiments disclosed herein are provided for explanatory purposes and are not intended to be limiting, with the true scope being indicated by the following claims.

1. A computer-implemented method of training a detector head for object detection of a training object category based on a frozen vision and language model (VLM), comprising:
receiving, by a computing device, the frozen VLM pre-trained on a plurality of image-text pairs;
determining, for an image embedding generated by a pre-trained image encoder of the frozen VLM and by the detector head, a detection region embedding indicative of one or more regions of interest in an image;
generating, by a pre-trained text encoder of the frozen VLM, a text embedding of the training object category;
predicting, by the detector head and based on the detection region embedding and the text embedding of the training object category, an object from a target object vocabulary associated with the training object category; and
providing, by the computing device, the pre-trained frozen VLM and the trained detector head.

2. The computer-implemented method of claim 1, wherein the predicting of the object comprises:
determining, by the detector head, one or more detection scores for the one or more regions of interest, wherein the one or more detection scores for the one or more regions of interest is indicative of the predicted object.

3. The computer-implemented method of claim 2, wherein the predicting of the object comprises training the detector head to predict one or more object detection boxes and associated masks corresponding to the one or more regions of interest, and wherein the one or more detection scores are associated with the one or more predicted object detection boxes.

4. The computer-implemented method of claim 1, wherein the training of the detector head is based on one or more of a box region loss, a box classification loss, or a mask classification loss.

5. The computer-implemented method of claim 1, wherein the detector head comprises a first stage and a second stage, and wherein the determining of the detection region embedding is performed by the first stage, and wherein the determining of the text embedding is performed by the second stage.

6. The computer-implemented method of claim 1, wherein the detector head is a neural network.

7. The computer-implemented method of claim 6, wherein the detector head is one of a Mask R-CNN or a Faster R-CNN.

8. The computer-implemented method of claim 1, wherein the detector head further comprises a feature pyramid network.

9. The computer-implemented method of claim 1, wherein the pre-trained text encoder and the pre-trained image encoder of the frozen VLM are jointly trained based on contrastive learning.

10. The computer-implemented method of claim 1, wherein the pre-trained image encoder comprises a (i) feature extractor to generate the image representation for the image, and (ii) a feature pooling layer.

11. The computer-implemented method of claim 10, wherein the feature extractor comprises a ResNet-50 architecture.

12. The computer-implemented method of claim 10, wherein the feature pooling layer is an attention layer of the image encoder.

13. The computer-implemented method of claim 1, further comprising:
maintaining an image normalization scheme of the pre-trained frozen VLM to enable open vocabulary object detection.

14. The computer-implemented method of claim 1, further comprising:
receiving, by the computing device, the pre-trained frozen VLM and the trained detector head, the pre-trained frozen VLM having been trained on the collection of image-text pairs of a first dataset, and the detector head having been trained on a first collection of training object categories of the first dataset; and
testing, by the computing device, the detector head on a second dataset comprising a second collection of inference object categories, wherein the testing comprises substituting the first collection of training object categories of the first training dataset with the second collection of inference object categories of the second dataset.

15. A computer-implemented method of applying a trained detector head for object detection of a training object category based on a frozen vision and language model (VLM), comprising:
receiving, by a computing device, an input image;
applying a trained neural network for object detection, wherein the neural network comprises the frozen VLM pre-trained on a plurality of image-text pairs, and the trained detector head associated with the pre-trained frozen VLM and pre-trained on the training object category;
determining, for an image embedding generated by a pre-trained image encoder of the frozen VLM and by the detector head, a detection region embedding indicative of one or more regions of interest in the input image;
predicting, by the detector head and based on the detection region embedding and a text embedding of the training object category, an object from a target object vocabulary associated with the training object category; and
providing, by the computing device, the input image with the object from the target object vocabulary.

16. The computer-implemented method of claim 15, wherein the predicting of the object comprises:
determining, by the trained detector head, one or more detection scores for the one or more regions of interest, wherein the one or more detection scores for the one or more regions of interest is indicative of the predicted object.

17. The computer-implemented method of claim 16, wherein the predicting of the object comprises predicting one or more object detection boxes and associated masks corresponding to the one or more regions of interest, and wherein the one or more detection scores are associated with the one or more predicted object detection boxes.

18. The computer-implemented method of claim 15, further comprising:
providing, by the computing device, the predicted object from the target object vocabulary associated with the training object category.

19. The computer-implemented method of claim 15, further comprising:
receiving, by the pre-trained text encoder, an inference object category different from the training object category;
augmenting, by the trained detector head, the text embedding of the training object category with an additional embedding of the inference object category, and
wherein the predicting of the object comprises predicting, based on the augmented text embedding and the detection region embedding, an additional object from an augmented target object vocabulary associated with the training object category and the inference object category.

20. The computer-implemented method of claim 19, wherein the predicting of the additional object comprises:
determining, by the trained detector head, one or more augmented detection scores for the one or more regions of interest, wherein the one or more augmented detection scores for the one or more regions of interest is indicative of the predicted additional object.

21. The computer-implemented method of claim 20, wherein the pre-trained image encoder comprises a feature pooling layer trained to generate one or more VLM region embeddings, and the method further comprising:
generating, by the feature pooling layer, one or more VLM scores corresponding to the one or more regions of interest, wherein the one or more VLM scores is based on the one or more VLM region embeddings and the augmented text embedding; and
determining one or more open vocabulary detection scores corresponding to the one or more regions of interest, wherein the one or more open vocabulary detection scores is based on the one or more augmented detection scores and the one or more VLM scores.

22. The computer-implemented method of claim 21, wherein the determining of the one or more open vocabulary detection scores comprises determining a geometric mean of the one or more augmented detection scores and the one or more VLM scores.

23. The computer-implemented method of claim 21, wherein the feature pooling layer is an attention layer of the pre-trained image encoder.

24. The computer-implemented method of claim 15, wherein the detector head is a neural network.

25. The computer-implemented method of claim 24, wherein the detector head is one of a Mask R-CNN or a Faster R-CNN.

26. The computer-implemented method of claim 24, the detector head having been trained to perform one-stage object detection.

27. The computer-implemented method of claim 24, wherein the detector head has been trained to perform two-stage object detection, wherein the determining of the detection region embedding is performed by a first stage, and wherein the determining of the text embedding is performed by a second stage.

28. The computer-implemented method of claim 15, wherein the detector head further comprises a feature pyramid network.

29. The computer-implemented method of claim 15, the pre-trained text encoder and the pre-trained image encoder of the frozen VLM having been jointly trained based on contrastive learning.

30. A computing device for training a detector head for object detection of a training object category based on a frozen vision and language model (VLM), comprising:
one or more processors; and
data storage, wherein the data storage has stored thereon computer-executable instructions that, when executed by the one or more processors, cause the computing device to carry out functions comprising:
receiving, by a computing device, the frozen VLM pre-trained on a plurality of image-text pairs;
determining, for an image embedding generated by a pre-trained image encoder of the frozen VLM and by the detector head, a detection region embedding indicative of one or more regions of interest in an image;
generating, by a pre-trained text encoder of the frozen VLM, a text embedding of the training object category;
predicting, by the detector head and based on the detection region embedding and the text embedding of the training object category, an object from a target object vocabulary associated with the training object category; and
providing, by the computing device, the pre-trained frozen VLM and the trained detector head.

31. (canceled)

32. (canceled)

33. (canceled)

34. (canceled)

35. A computing device for applying a trained detector head for object detection of a training object category based on a frozen vision and language model (VLM), comprising:
one or more processors; and
data storage, wherein the data storage has stored thereon computer-executable instructions that, when executed by the one or more processors, cause the computing device to carry out functions comprising:
receiving, by a computing device, an input image;
applying a trained neural network for object detection, wherein the neural network comprises the frozen VLM pre-trained on a plurality of image-text pairs, and the trained detector head associated with the pre-trained frozen VLM and pre-trained on the training object category;
determining, for an image embedding generated by a pre-trained image encoder of the frozen VLM and by the detector head, a detection region embedding indicative of one or more regions of interest in the input image;
predicting, by the detector head and based on the detection region embedding and a text embedding of the training object category, an object from a target object vocabulary associated with the training object category; and
providing, by the computing device, the input image with the object from the target object vocabulary.
